(19) United States
(12) Patent Application Publication
(10) Pub. No.: US 2025/0043810 A1
(43) Pub. Date: Feb. 6, 2025

(54) SOLAR TRACKER VARIABLE CONNECTION ANGULAR ORIENTATIONS

(71) Applicant: Nextracker LLC, Fremont, CA (US)

(72) Inventors: Venkata Nitin Mythreya Yadlapalli, Nellore (IN); Bhanu Rekha Bandhakavi, Hyderabad (IN); Ricardo Delgado-Nanez, San Jose, CA (US); David E. Kresse, Walnut Creek, CA (US); Sri Rama Krishna Tammu, Krishna, Andhra Pradesh (IN)

(21) Appl. No.: 18/789,942

(22) Filed: Jul. 31, 2024

Related U.S. Application Data
(60) Provisional application No. 63/517,147, filed on Aug. 2, 2023.

(51) Int. Cl. F16B 7/18; F16C 17/02; H02S 20/32

(52) U.S. Cl. CPC F16B 7/182; F16C 17/02; H02S 20/32; F16C 2380/00

(57) ABSTRACT

A flexible tube connector includes a central tube region, a first tube end portion, a second tube end portion, and one or more flexibility features. The first tube end portion extends out from one end of the central tube region, and the first tube end portion is configured to couple to a first torque tube of a solar tracker apparatus. The second tube end portion extends out from another, opposite end of the central tube region, and the second tube end portion is configured to couple to a second torque tube of the solar tracker apparatus. The one or more flexibility features are at the central tube region, and the one or more flexibility features are configured to cause the first tube end portion to connect to the first torque tube and the second tube end portion to connect to the second torque tube at a plurality of angular orientations.

### RELATED APPLICATION

This disclosure claims priority to U.S. provisional patent application No. 63/517,147, filed on Aug. 2, 2023, the entire contents of which are hereby incorporated by reference.

### TECHNICAL FIELD

This disclosure relates generally to device, system, and method embodiments for facilitating a range of connection orientations between components of a solar tracker. Embodiments disclosed herein can be configured to facilitate one or more connections between solar tracker components at any one of a variety of angular orientations as suited for a given local terrain at a given local connection location along an extent of a solar tracker.

### BACKGROUND

One of the most significant, costly, and time-consuming aspects relating to the manufacture and installation of solar trackers is the requirement that the site be substantially level. While certainly some sites are generally level, most terrain has some undulation, and in some instances, quite a significant pitch to the terrain. In practical terms, this requires installers of solar trackers to conduct a significant amount of earth excavation and moving. Such earthworks are time consuming, require significant amounts of heavy machinery, and are subject to a significant amount of regulation. Indeed, some projects have been halted owing to the environmental impact of the earthmoving required to produce a relatively level site for the installation of the solar trackers.

An alternative to massive earth works is the use of custom pier heights. A solar tracker is typically comprised of a torque tube that supports the solar panels and is itself supported by piers embedded into the ground. A second method of addressing changing terrain is the use of piers which are formed specifically for the location in which they will be embedded in the ground. In this way, the level of the torque tube can remain consistent without requiring the moving or removing of earth. However, while the earthmoving costs are reduced, there are additional financial and timing costs associated with custom piers. First, these are custom length piers which require custom length determinations. Next, the custom piers need to be accurately identified and sorted with respect to the site so than can be installed in their custom location. All of this requires significant resource and ultimately increases the cost of installation.

To alleviate the logistical and financial burden associated with the use of custom length piers, an alternative is to utilize identical pier lengths and permit the solar trackers to follow the natural undulations of the terrain. As can be appreciated, the torque tubes extending between each pier must be permitted to rotate and effectuate rotation of an adjacent torque tube, which due to the topography of the terrain, may or may not be placed in coaxial alignment therewith.

### SUMMARY

This disclosure in general describes embodiments of devices, systems, and methods for facilitating a range of connection angular orientations between components of a solar tracker. Embodiments disclosed herein can be configured to facilitate one or more connections between solar tracker components at any one of a variety of angular orientations as suited for a given local terrain at a given local connection location along an extent of a solar tracker. As such, embodiments disclosed herein can allow for a given connection between solar tracker components to be made at an angular orientation that is suited for the given terrain gradient at that given connection location. In this way, a solar tracker can be installed and utilized at relatively high gradient terrains by allowing for connections, during assembly and installation of the solar tracker, between solar tracker components that are tailored, via an angular orientation of the connection between components, to the local terrain gradient at the particular location of that connection between components.

One embodiment includes a solar tracker bearing housing assembly. This embodiment of the solar tracker bearing housing includes a housing, a pin aperture at the housing, a rotatable ring rotatably seated at the pin aperture, and a pin received at the rotatable ring. The pin is configured to rotatably connect to at least one torque tube to cause the pin to rotate with the torque tube in a first plane, and the pin is configured to pivot with the rotatable ring in a second, different plane to change an angular orientation of the pin relative to the pin aperture.

In a further embodiment of this assembly, the assembly additionally includes a cradle that is defined at the pin aperture. The rotatable ring is rotatably seated at the cradle. For example, the cradle can include an upper ring retention fit at the pin aperture and a lower ring retention fit at the pin aperture. The upper ring retention fit can define at least an upper portion of the pin aperture at a location above the pin, and the lower ring retention fit can define at least a lower portion of the pin aperture at a location below the pin. The upper ring retention fit and the lower ring retention fit can be configured to maintain the rotatable ring rotatably seated at the pin aperture. In a further such example, the rotatable ring can define a curved outer surface, the upper ring retention fit can define a first curved surface at the upper portion of the pin aperture to receive the curved outer surface of the rotatable ring, and the lower ring retention fit can define a second curved surface at the lower portion of the pin aperture to receive the curved outer surface of the rotatable ring. In such an example, the rotatable ring can be configured to rotate at the first curved surface of the upper ring retention fit and to rotate at the second curved surface of the lower ring retention fit to cause the pin to pivot in the second plane to change the angular orientation of the pin relative to the pin aperture. For instance, according to one further, more specific such example, the housing can include a first hoop coupled to a second hoop. The upper ring retention fit can be formed by each of the first hoop and the second hoop, the lower ring retention fit can be formed by each of the first hoop and the second hoop, and the rotatable ring can be rotatably seated at an interface of the first hoop and the second hoop.

In a further embodiment of this assembly, the cradle can further include a first interference stop at the upper portion of the pin aperture at the location above the pin and a second interference stop at the lower portion of the pin aperture at the location below the pin. The first interference stop and the second interference stop can be configured to limit a range within which the pin is configured to pivot with the rotatable ring in the second plane to change the angular orientation of the pin relative to the pin aperture. For example, the first interference stop can be at or adjacent to a first side end portion of the pin aperture at the upper portion of the pin aperture, and the second interference stop can be at or adjacent to a second, opposite side end portion of the pin aperture at the lower end portion of the pin aperture. In one further such embodiment, the cradle can additionally include a third interference stop at the upper portion of the pin aperture at the location above the pin and a fourth interference stop at the lower portion of the pin aperture at the location below the pin. The first interference stop and the second interference stop can be configured to limit, in a first pivot direction, the range within which the pin is configured to pivot with the rotatable ring. The third interference stop and the fourth interference stop can be configured to limit, in a second, opposite direction, the range within which the pin is configured to pivot with the rotatable ring. The third interference stop can be at or adjacent to the second side end portion of the pin aperture at the upper portion of the pin aperture, and the fourth interference stop can be at or adjacent to the first side end portion of the pin aperture at the lower portion of the pin aperture.

In a further embodiment of this assembly, the pin can be configured to translate relative to the rotatable ring in each of a first radial direction away from the housing and a second, opposite radial direction away from the housing.

In a further embodiment of this assembly, the first plane can be normal to the second plane. For example, the pin can be configured to rotatably connect to a first torque tube to suspend the first torque tube at a first side of the housing such that when the pin pivots with the rotatable ring in the second plane the pin causes a change in an angular orientation of the first torque tube relative to the pin aperture. And the pin can be configured to rotatably connect to a second torque tube to suspend the second torque tube at a second, opposite side of the housing such that when the pin pivots with the rotatable ring in the second plane the pin causes a change in an angular orientation of the second torque tube relative to the pin aperture.

Another embodiment includes a variable angular orientation torque tube connector assembly. This assembly includes a central tubular connector component, a first end connector component, and a second end connector component. The central tubular connector component includes a central tube body, a first central tube flange at a first end of the central tube body, and a second central tube flange at a second, opposite end of the central tube body. The first end connector component is coupled to the central tubular connector component. The first end connector component includes a first end component body and a first end component flange. The first end component flange is at a first end of the first end component body. The second end connector component is coupled to the central tubular connector component. The second end connector component includes a second end component body and a second end component flange. The second end component flange is at a first end of the second end component body.

In a further embodiment of this assembly, the first end component flange and the first central tube flange interface, and the first end component flange and the first central tube flange are configured, upon relative rotation therebetween, to change an angular orientation between the first end connector component and the central tubular connector component. Similarly, the second end component flange and the second central tube flange interface, and the second end component flange and the second central tube flange are configured, upon relative rotation therebetween, to change an angular orientation between the second end connector component and the central tubular connector component.

In a further embodiment of this assembly, the first central tube flange projects outward from the central tube body at the first end of the central tube body, and the first central tube flange extends along all of a perimeter at the first end of the central tube body. Similarly for this further embodiment, the second central tube flange projects outward from the central tube body at the second end of the central tube body, and the second central tube flange extends along all of a perimeter at the second end of the central tube body. For example, the first end component flange can project outward from the first end component body at the first end of the first end component body, and the first end component flange can extend along all of a perimeter at the first end of the first end component body. Similarly, the second end component flange can project outward from the second end component body at the first end of the second end component body, and the second end component flange can extend along all of a perimeter at the first end of the second end component body.

For some such further embodiments, the first central tube flange can define a first planar surface, the second central tube flange can define a second planar surface, the first end component flange can define a planar surface, and the second end component flange can define a planar surface. The first planar surface defined by the first central tube flange can be a first skewed orientation planar surface, the second planar surface defined by the second central tube flange can be a second skewed orientation planar surface, the planar surface defined by the first end component flange can be a third skewed orientation planar surface that is an inverse skew of the first skewed orientation planar surface at the first central tube flange, and the planar surface defined by the second end component flange can be a fourth skewed orientation planar surface that is an inverse skew of the second skewed orientation planar surface at the first central tube flange.

For other such further embodiments, the first central tube flange can define a first curved surface, the second central tube flange can define a second curved surface, the first end component flange can define a curved surface, and the second end component flange can define a curved surface. The first curved surface defined by the first central tube flange can curve toward the central tube body, the second curved surface defined by the second central tube flange can curve toward the central tube body and toward the first curved surface, the curved surface defined by the first end component flange can curve away from the first end component body and toward the central tube body, and the curved surface defined by the second end component flange can curve away from the second end component body and toward the central tube body.

In a further embodiment of this assembly, the first central tube flange includes a first plurality of fastening apertures, and the second central tube flange includes a second plurality of fastening apertures, the first end component flange includes a third plurality of fastening apertures such that the first end connector component is coupled to the central tubular connector component at at least one of the first plurality of fastening apertures and at at least one of the third plurality of fastening apertures, and the second end component flange includes a fourth plurality of fastening apertures such that the second end connector component is coupled to the central tubular connector component at at least one of the second plurality of fastening apertures and at at least one of the fourth plurality of fastening apertures.

An additional embodiment includes a flexible torque tube connector. This flexible torque tube connector embodiment includes a central tube region, a first tube end portion, a second tube end portion, and one or more flexibility features. The first tube end portion extends out from one end of the central tube region, and the first tube end portion is configured to couple to a first torque tube of a solar tracker apparatus. The second tube end portion extends out from another, opposite end of the central tube region, and the second tube end portion is configured to couple to a second torque tube of the solar tracker apparatus. The one or more flexibility features are located at the central tube region, and the one or more flexibility features are configured to cause the first tube end portion to connect to the first torque tube and the second tube end portion to connect to the second torque tube at a plurality of angular orientations.

In a further embodiment of this flexible tube connector, the first tube end portion includes one or more torque tube fastening apertures, and the second tube end portion includes one or more torque tube fastening apertures. The one or more flexibility features can be located between the one or more torque tube fastening apertures at the first tube end portion and the one or more torque tube fastening apertures at the second tube end portion.

In a further embodiment of this flexible tube connector, the one or more flexibility features can be configured to cause the first tube end portion to connect to the first torque tube at a plurality of angular orientations relative to the central tube region, and the one or more flexibility features can be configured to cause the second tube end portion to connect to the second torque tube at a plurality of angular orientations relative to the central tube region.

In a further embodiment of this flexible tube connector, the one or more flexibility features include a series of corrugations at the central tube region.

As one example, the series of corrugations at the central tube region can include a plurality of recessed portions at an outer surface of the central tube region, and the plurality of recessed portions can be spaced apart from one another along at least a portion of a length of the central tube region. For some such examples, each of the plurality of recessed portions can extend around an entire perimeter of the outer surface of the central tube region. Additionally of alternative for some such examples, the central tube region can include a non-corrugated region along a portion of the length of the central tube region, and this non-corrugated region can be bounded at one side by the plurality of recessed portions at the outer surface of the central tube region and bounded at another, opposite side by the plurality of recessed portions at the outer surface of the central tube region.

As another example, the series of corrugations at the central tube region can include a plurality of projection portions at an outer surface of the central tube region, and the plurality of projection portions spaced apart from one another along at least a portion of a length of the central tube region. For some such examples, the central tube region can include a non-corrugated region along a portion of the length of the central tube region, and this non-corrugated region can be bounded at one side by the plurality of projection portions at the outer surface of the central tube region and bounded at another, opposite side by the plurality of projection portions at the outer surface of the central tube region.

Another embodiment includes a system. This system embodiment includes a bearing housing assembly that is configured to rotatably support a first torque tube and a second torque tube and includes a flexible tube connector that is configured to connect to the first torque tube and the second torque tube at a plurality of angular orientations. The bearing housing assembly can include a housing, a pin aperture at the housing, a rotatable ring rotatably seated at the pin aperture, and a pin received at the rotatable ring. The pin can be configured to rotatably connect to at least one torque tube to cause the pin to rotate with the torque tube in a first plane, and the pin can be configured to pivot with the rotatable ring in a second, different plane to change an angular orientation of the pin relative to the pin aperture. The flexible tube connector can include a central tube region, a first tube end portion, a second tube end portion, and one or more flexibility features. The first tube end portion extends out from one end of the central tube region, and the first tube end portion is configured to couple to a first torque tube of a solar tracker apparatus. The second tube end portion extends out from another, opposite end of the central tube region, and the second tube end portion is configured to couple to a second torque tube of the solar tracker apparatus. The one or more flexibility features are located at the central tube region, and the one or more flexibility features are configured to cause the first tube end portion to connect to the first torque tube and the second tube end portion to connect to the second torque tube at a plurality of angular orientations.

In a further embodiment of this system, the pin is received at the rotatable ring spaced apart from and above the flexible tube connector. The housing of the bearing housing assembly can be movable relative to the central tube region of the flexible tube connector.

In a further embodiment of this system, the system additionally includes a first rail coupled to the pin at a first side of the housing of the bearing housing assembly and a second rail coupled to the pin at a second, opposite side of the housing of the bearing housing assembly. The first rail can be configured to couple to one of the first torque tube and the central tube region to rotatably support the first torque tube, and the second rail can be configured to couple to one of the second torque tube and the central tube region to rotatably support the second torque tube. The first tube end portion can include one or more torque tube fastening apertures at a location along the first tube end portion longitudinally offset from a first end of the pin, and the second tube end portion can include one or more torque tube fastening apertures at a location along the second tube end portion longitudinally offset from the a second end of the pin. In one such example, the one or more flexibility features can be located between the one or more torque tube fastening apertures at the first tube end portion and the one or more torque tube fastening apertures at the second tube end portion.

In a further embodiment of this system, the one or more flexibility features can be configured to cause the first tube end portion to connect to the first torque tube at a plurality of angular orientations relative to the central tube region, and the one or more flexibility features can be configured to cause the second tube end portion to connect to the second torque tube at a plurality of angular orientations relative to the central tube region. The one or more flexibility features can include a series of corrugations at the central tube region.

In a further embodiment of this system, the pin can be configured to translate relative to the rotatable ring in each of a first radial direction away from the housing and a second, opposite radial direction away from the housing.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIGS. 1A-1B illustrate an embodiment of a solar tracker apparatus. FIG. 1A is a schematic perspective view of the solar tracker apparatus in isolation, and FIG. 1B is a schematic elevation view of the solar tracker apparatus installed at relatively high gradient terrain.

FIGS. 2A-2G illustrate an embodiment of a bearing housing assembly, for instance, for facilitating solar tracker installation at relatively high gradient terrain. FIG. 2A is a perspective view of the bearing housing assembly, FIG. 2B is a cross-sectional view of the bearing housing assembly taken along line A-A in FIG. 2A, FIG. 2C is a perspective view of a pin component of the bearing housing assembly of FIG. 2A, FIG. 2D is a perspective view of a ring component of the bearing housing assembly of FIG. 2A, FIG. 2E is the cross-sectional view of FIG. 2B showing the pin at a horizontal angular orientation, FIG. 2F is the cross-sectional view of FIG. 2B showing the pin at a skewed angular orientation between horizontal and vertical, and FIG. 2G is the cross-sectional view of FIG. 2B showing the pin at the skewed angular orientation between horizontal and vertical as in FIG. 2F but also showing the pin translated.

FIGS. 3A-3D illustrate an embodiment of a flexible tube connector. FIG. 3A is a perspective view of the flexible tube connector installed at the solar tracker assembly, FIG. 3B is a perspective view of the flexible tube connector connecting two torque tubes of the solar tracker assembly as at FIG. 3A, FIG. 3C is a perspective view of the flexible tube connector in isolation, and FIG. 3D is a cross-sectional view of the flexible tube connector taken along line B-B in FIG. 3C.

FIGS. 4A-4G illustrate an embodiment of a variable angular orientation tubular connector assembly, for instance, for use in connecting two torque tubes of the solar tracker. FIG. 4A is an elevational view of the variable angular orientation tubular connector assembly installed to connect two torque tubes at a first angular orientation, FIG. 4B is an elevational view of the variable angular orientation tubular connector assembly installed to connect two torque tubes at a second, different angular orientation, FIG. 4C is a close-up perspective view of the variable angular orientation tubular connector assembly at one angular orientation to connect two torque tubes in isolation, FIG. 4D is a close-up perspective view of the variable angular orientation tubular connector assembly at another, different angular orientation to connect two torque tubes in isolation, FIG. 4E is a perspective view of a central tubular connector component of the variable angular orientation tubular connector, FIG. 4F is a perspective view of an end connector component of the variable angular orientation tubular connector, and FIG. 4G is a perspective view of a guide ring component of the variable angular orientation tubular connector.

FIGS. 5A-5G illustrate another embodiment of a variable angular orientation tubular connector assembly, for instance, for use in connecting two torque tubes of the solar tracker. FIG. 5A is a perspective view of the variable angular orientation tubular connector assembly installed to connect two torque tubes at a first angular orientation, FIG. 5B is an elevational view of the variable angular orientation tubular connector assembly connecting the two torque tubes at the first angular orientation as in FIG. 5A, FIG. 5C is a perspective view of the variable angular orientation tubular connector assembly in isolation at the first angular orientation, FIG. 5D is an elevational view of the variable angular orientation tubular connector assembly connecting the two torque tubes at a second, different angular orientation, FIG. 5E is a perspective view of the variable angular orientation tubular connector assembly connecting the two torque tubes at the second, different angular orientation as in FIG. 5D, FIG. 5F is a perspective view of a central tubular connector component of the variable angular orientation tubular connector, and FIG. 5G is a perspective view of an end connector component of the variable angular orientation tubular connector.

FIGS. 6A-6C illustrate another embodiment of a bearing housing assembly, for instance, for facilitating solar tracker installation at relatively high gradient terrain. FIG. 6A is a cross-sectional view showing a pin at a horizontal angular orientation, FIG. 6B is a cross-sectional view showing the pin at a skewed angular orientation between horizontal and vertical, and FIG. 6C is a cross-sectional view showing the pin at the skewed angular orientation between horizontal and vertical as in FIG. 6B but also showing the pin translated.

FIGS. 7A-7B illustrate another embodiment of a flexible tube connector. FIG. 7A is a perspective view of a system that includes the flexible tube connector and a bearing housing assembly configured for rotatably connecting two torque tubes of a solar tracker. FIG. 7B is a perspective view of the flexible tube connector embodiment in isolation.

FIGS. 8A-8B illustrate an additional embodiment of a flexible tube connector. FIG. 8A is a perspective view of a system that includes the flexible tube connector embodiment and a bearing housing assembly configured for rotatably connecting two torque tubes of a solar tracker. FIG. 8B is a perspective view of the flexible tube connector embodiment in isolation.

FIG. 9 is an elevational view of another embodiment of a flexible tube connector incorporated into a system that includes the embodiment of the flexible tube connector and a bearing housing assembly configured for rotatably connecting two torque tubes of a solar tracker.

FIGS. 10A-10B illustrate a further embodiment of a flexible tube connector. FIG. 10A is an elevational view of a system that includes the flexible tube connector embodiment and a bearing housing assembly configured for rotatably connecting two torque tubes of a solar tracker. FIG. 10B is a perspective view of the flexible tube connector embodiment in isolation.

FIGS. 11A-11D illustrate another embodiment of a flexible tube connector. FIG. 11A is a perspective view of the flexible tube connector embodiment in isolation, FIG. 11B is an elevational view of a system that includes the flexible tube connector embodiment and a bearing housing assembly configured for rotatably connecting two torque tubes of a solar tracker, FIG. 11C is a cross-sectional view taken along line C-C at FIG. 11B, and FIG. 11D is an elevational view of the system of FIGS. 11B and 11C showing the bearing housing and flexible tube connector rotatably connecting two torque tubes at one exemplary angular orientation.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, and methods configured for facilitate one or more connections between solar tracker components at any one of a variety of angular orientations as suited for a given local terrain at a given local connection location along an extent of a solar tracker. Accordingly, such embodiments disclosed herein can be useful in allowing for solar tracker component connections at relatively uneven, high gradient terrain thereby allowing solar trackers to be deployed at a wider variety of geographical locations and reducing the costs associated with such deployments. For instance, embodiments disclosed herein can facilitate a first angular connection between solar tracker components for a first terrain location along the solar tracker and can facilitate a second, difference angular connection between solar tracker components for a second, different terrain location, having a different terrain gradient than the first terrain location, along the solar tracker.

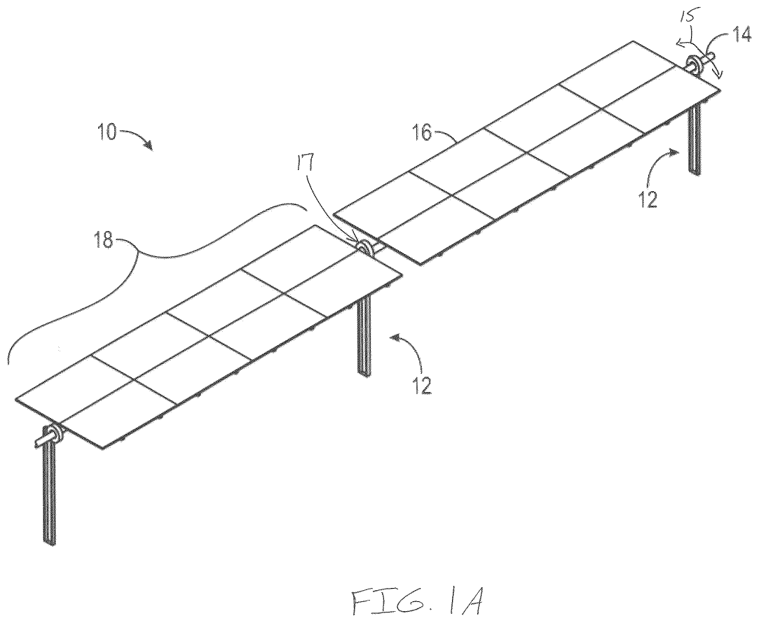

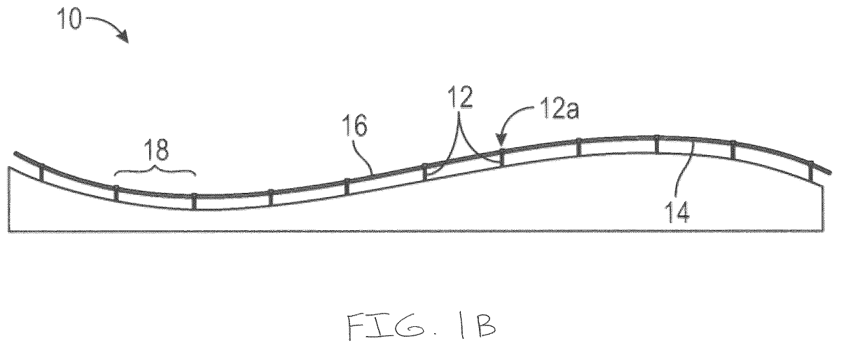

FIGS. 1A and 1B illustrate an embodiment of a solar tracker apparatus 10. FIG. 1A shows the solar tracker apparatus 10 in isolation, and FIG. 1B shows a schematic elevation view of the solar tracker apparatus 10 installed at relatively high gradient terrain.

The solar tracker apparatus 10 can include a plurality of piers 12 disposed in spaced relation to one another and embedded in the earth. The solar tracker apparatus 10 can include one or more torque tubes 14 that can extend between adjacent piers 12 and be rotatably supported at each pier 12. The solar tracker apparatus 10 can further include a plurality of solar modules 16 (e.g., solar panels having photovoltaic cells) supported at the respective torque tube 14. The one or more torque tubes can be rotated in directions 15 so as to change an angle of the solar modules 16 (e.g., throughout a day as the location of the sun changes relative to the solar modules 16). A bearing housing assembly 17 can be configured to rotatably connect torque tubes 14 along a span of the solar tracker apparatus 10. The span between two adjacent piers 12 is referred to as a bay 18 and, for example, in certain applications may be generally in the range of about 8 meters in length. A plurality of solar tracker apparatuses 10 may be arranged in a north-south longitudinal orientation to form a solar array.

FIG. 1B shows the solar tracker apparatus 10 installed at undulating, relatively high gradient terrain. Each pier of the plurality of piers 12 can be driven into the earth such that substantially the same amount of reveal is present for each. In this manner, the distance between an upper portion 12a of each pier and the surface of the earth can be substantially the same. In this manner, the overall length of each pier 12 may be substantially similar, thereby eliminating the need for determining a custom length for each pier at a particular location. Further, by maintaining a substantially similar reveal, the overall length of each pier 12 may be reduced, as the length of the pier 12 does not need to accommodate depressions in the terrain in order to ensure a proper amount of the pier 12 is driven into the ground while maintaining a substantially level height with adjacent piers 12.

As can be appreciated, with the reveal for each pier 12 being substantially similar, the torque tube 14, extending between each adjacent pier 12, must follow the differing heights of the piers 12, resulting in the torque tube 14 being substantially parallel to the contours of the terrain. As can be appreciated, the change in slope along the torque tube 14 defines a corresponding angle with respect to each respective pier 12. In this manner, the angle of a torque tube 14 on one side of a pier 12 may be different than an angle of an adjacent torque tube 14 on the other side of the pier 12. To accommodate this difference in angles of each adjacent torque tube 14 relative to another, as disclosed herein, the solar tracker apparatus 10 can include one or more components configured to facilitate variable angle connections at the solar tracker apparatus 10 as suited for a given local terrain gradient at the particular component connection location.

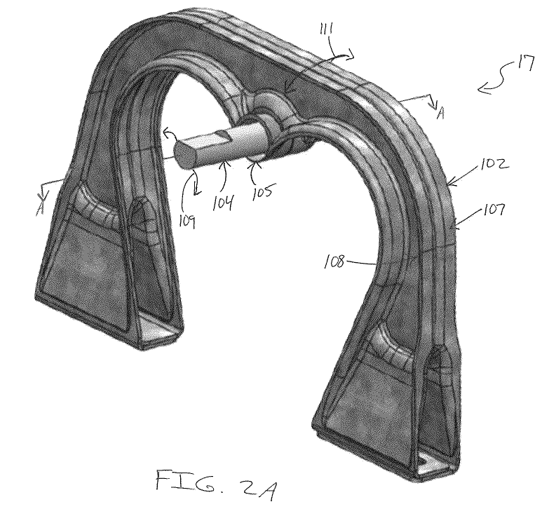

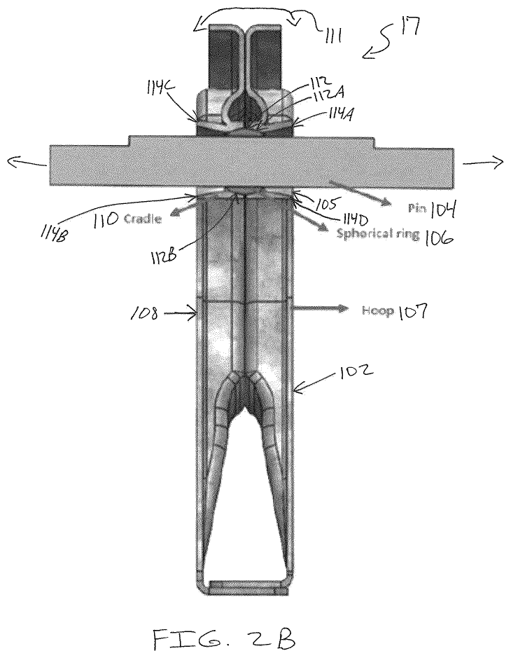

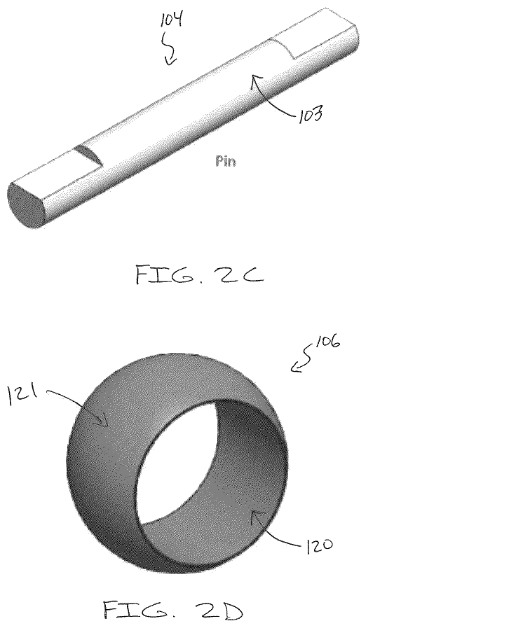

FIGS. 2A-2G illustrate an embodiment of the bearing housing assembly 17, for instance, for facilitating solar tracker installation at relatively high gradient terrain, and, as such, the bearing housing assembly 17 can be referred to as a variable angular orientation connection bearing housing assembly 17. The bearing housing assembly 17 can be configured to rotatably connect to one or more torque tubes 14. For example, the bearing housing assembly 17 can be configured to connect to one torque tube 14 at one side of the bearing housing assembly 17 and to connect to another torque tube 14 at another, opposite side of the bearing housing assembly 17. In such an arrangement, the bearing housing assembly 17 can be configured to transfer torque from the one torque tube 14 at the one side of the bearing housing assembly 17 to the another torque tube 14 at the opposite side of the bearing housing assembly 17.

FIG. 2A is a perspective view of the bearing housing assembly 17, and FIG. 2B is a cross-sectional view of the bearing housing assembly 17 taken along line A-A in FIG. 2A. The bearing housing assembly 17 can include a bearing housing 102, a pin 104, and a ring 106. In the illustrated embodiment, the bearing housing 102 can be formed by a first hoop 107 and a second hoop 108 which together can define an interior of the bearing housing 102. The pin 104 can be rotatably seated within a pin aperture 105 that is defined at the bearing housing 102. And, in some examples, the pin 104 can be configured to connect to and rotatably suspend one torque tube at one side of the bearing housing 102 and to connect to and rotatably suspend another torque tube at another, opposite side of the bearing housing 102. In this way, the pin 104 can be configured to rotate in directions 109, relative to the pin aperture 105 and bearing housing 102, to transfer torque from the one torque tube connected (e.g., indirectly) at one side of the pin 104 to the another torque tube connected at the opposite side of the pin 104. In other examples, the pin 104 can be configured to connect to and rotatably suspend a single torque tube, with one portion of the single torque tube at one side of the bearing housing 102 and another portion of the single torque tube at another, opposite side of the bearing housing 102. The ring 106 can be rotatably seated within the bearing housing 102, and the ring 106 can be configured to receive the pin 104. The ring 106 can be rotatably seated within the bearing housing 102 so as to pivot, relative to the bearing housing 102, in directions 111, The pivotable directions 111 of the ring 106 can be in a plane that is normal to a plane within which the directions 109 sit. Thus, the pin 104 can rotate in the directions 109 that are within a first plane to transfer torque between torque tubes while the ring 106 can pivot in the directions 111 that are within a second plane (e.g., that is perpendicular to the first plane). As the ring 106 pivots in the directions 111, the pin 104, via its coupling to the ring 106, can be pivoted relative to the bearing housing 102.

To facilitate the pivotable movement of the pin 104, via the ring 106, in the directions 111, the bearing housing 102 can define a cradle 110 thereat. The cradle 110 can be configured to rotatably receive and retain the ring 106 so as to allow the ring 106 to rotate in the directions 111 relative to the bearing housing assembly 102. To rotatably receive and retain the rings 106, the cradle 110 can include one or more ring retention fits 112 to receive and maintain the ring 106 at (e.g., within) the bearing housing 102. For example, the illustrated embodiment of the cradle 110 includes an upper ring retention fit 112A and a lower ring retention fit 112B. The upper ring retention fit 112A can define at least a portion of the pin aperture 105 at a location above the pin 104, and the lower ring retention fit 112B can defined at least a portion of the pin aperture 105 at a location below the pin 104. The upper ring retention fit 112A can be defined be an upper portion of the pin aperture 105 at the first hoop 107 and an upper portion of the pin receiving aperture 105 at the second hoop 108 such that when the first and second hoops 107, 108 are assembled together the bearing housing 102 can define the cradle 110 with the upper ring retention fit 112A. Likewise, the lower ring retention fit 112B can be defined be a lower portion of the pin aperture 105 at the first hoop 107 and a lower portion of the pin receiving aperture 105 at the second hoop 108 such that when the first and second hoops 107, 108 are assembled together the bearing housing 102 can define the cradle 110 with the lower ring retention fit 112A. To allow for rotation of the ring 106 relative to the bearing housing 102, the cradle 110 can define a cross-sectional shape that generally matches an exterior surface 121 (shown, e.g., at FIG. 2d) of the ring 106. Thus, for the illustrated embodiment where the cross-sectional shape of the exterior surface 121 of the ring 106 is generally circular, the upper ring retention fit 112A can define an upper portion of a circular cross-sectional shape at the cradle 110 while the lower ring retention fit 112B can define a lower portion of the circular cross-sectional shape at the cradle 110.

In addition, the cradle 110 can be configured to provide one or more interference stops 114 to limit the upper bounds of the pivotable movement of the pin 104 relative to the bearing housing assembly 102. For example, the cradle 110 can define a first interference stop 114A at one, upper side end portion of the pin aperture 105 (e.g., at an upper side end portion of the pin aperture at the first hoop 107) and a second interference stop 114B at an opposite, lower side end portion of the pin aperture 105 (e.g., at a lower side end portion of the pin aperture at the second hoop 108). The first and second first interference stops 114A, 114B can be configured to limit the extent of rotation of the pin 104 in one direction 111 relative the bearing housing 102. The cradle 110 can further define a third interference stop 114C at one, upper side end portion of the pin aperture 105 (e.g., at an upper side end portion of the pin aperture at the second hoop 108) and a fourth interference stop 114D at an opposite, lower side end portion of the pin aperture 105 (e.g., at a lower side end portion of the pin aperture at the first hoop 107). The third and fourth first interference stops 114C, 114D can be configured to limit the extent of rotation of the pin 104 in another direction 111 relative the bearing housing 102 (e.g., in a direction 111, relative to the bearing housing 102, that is opposite the direction which the first and second interference stops 114A, 114B limit the extent of rotation of the pin 104).

In the illustrated embodiment, the pin 104 can also be configured to translate relative to ring 106, and thus relative to the bearing housing 102. For example, a cross sectional shape of an interior surface 120 of the ring 106 (shown, e.g., at FIG. 2D) can generally match a cross-sectional shape of an exterior surface 103 of the pin 104. In this way, when the pin 104 is received at the interior surface 120 of the ring 106, the pin 104 can be configured to slide in directions 113, relative to the ring 106, that are generally radial relative to the bearing housing 102.

FIGS. 2C and 2D show, respectively, a perspective view of the pin 104 in isolation and a perspective view of the ring 106 in isolation. As illustrated here, the pin 104 includes the exterior surface 103, and the ring 106 includes the interior surface 120. As noted, the exterior surface 103 of the pin 104 can have a cross-sectional shape that generally matches the cross-sectional shape of the interior surface 120 of the ring 106. In the illustrated embodiment, this matching cross-section shape is circular, though in other embodiments a variety of other matching cross-sectional shapes can be used to facilitate translation of the pin 104 relative to the ring 106.

The ability of the bearing housing assembly 17 to facilitate pivoting and/or translation of the pin 104, via the ring 106, can be useful in accommodating different angles of torque tube connections at variable terrain gradients. FIGS. 2E-2G show the cross-sectional view of FIG. 2B with the pin 104 moved relative to the bearing housing 102 to various exemplary positions. In particular, FIG. 2E shows the pin 104 at the same position, relative to the bearing housing 102, as in FIG. 2B, which shows the pin 104 generally at a horizontal angular orientation relative to the bearing housing 102 (e.g., the pin 104 extends generally parallel to the longitudinal axis of the pin aperture 105 at the bearing housing 102). FIG. 2F shows the pin 104 pivoted relative to the bearing housing 102 such that the pin 104 is at a skewed angular orientation between horizontal and vertical relative to the bearing housing 102 (e.g., the pin 104 extends through the pin aperture 105 at a skewed angle relative to the longitudinal axis of the pin aperture 105). And FIG. 2G shows the pin 104 at the pivot location of FIG. 2F but with the pin 104 now translated, in a direction toward the hoop 107, relative to the ring 106 and the bearing housing assembly 102 (e.g., such that the pin 104 projects further out from the pin aperture 105 from the hoop 107 side of the bearing housing 102 than from the hoop 108 side of the bearing housing 102).

Because the bearing housing assembly 17 can allow for a variety of various positions of the pin 104 relative to the bearing housing 102 (e.g., a variety of various pivotable locations of the pin 104 relative to bearing housing 102 and/or a variety of translatable locations of the pin 104 relative to bearing housing 102), the bearing housing assembly 17 can be useful in facilitating a connection between two torque tubes or portions of the same torque tube (e.g., at opposite sides of the pin 104) at a variety of angular orientations relative to the bearing housing 102. This can be useful in allowing such torque tube connections via the bearing housing assembly 17 at a variety of different terrain gradients at a given bearing housing assembly 17 location along the solar tracker apparatus. Moreover, this configuration the bearing housing assembly 17 to allow for a variety of various positions of the pin 104 relative to the bearing housing 102 can facilitate generally vertical installation of the bearing housing assembly 17 at a given pier, as opposed to more complex skewed installation at a given pier.

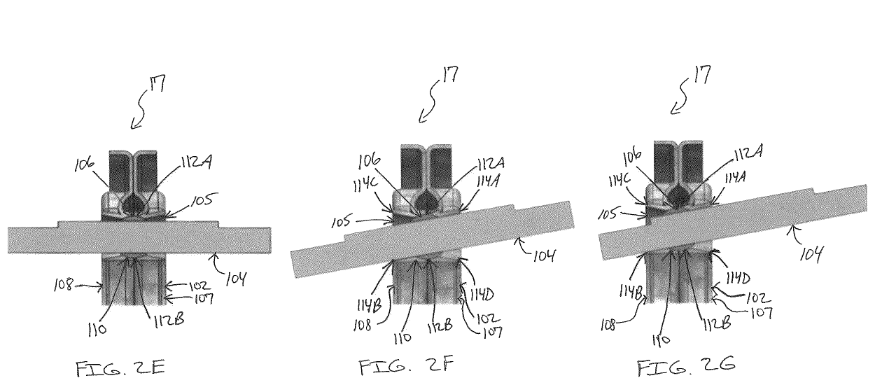

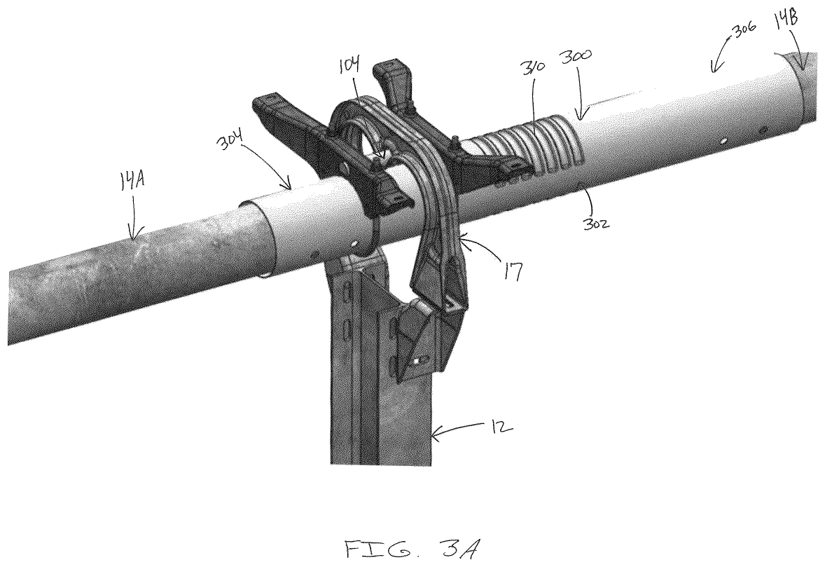

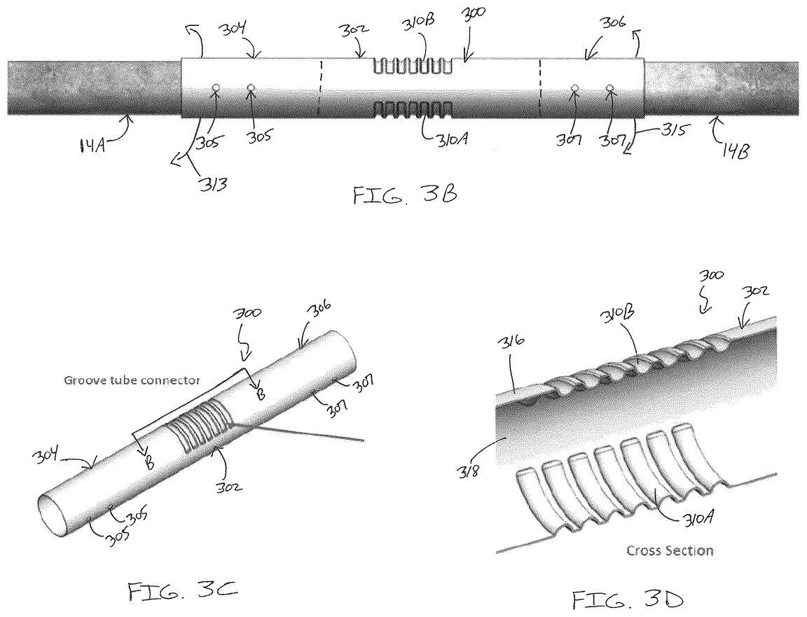

FIGS. 3A-3D illustrate an embodiment of a flexible tube connector 300. FIG. 3A shows a perspective view of the flexible tube connector 300 installed at the solar tracker apparatus 10 and relative to the bearing housing assembly 17 (with rails at each side of bearing housing assembly 17 receiving the pin of the bearing housing assembly 17, e.g., to help retain the pin at the cradle of the bearing housing assembly 17 when the pin translates), FIG. 3B shows a perspective view of the flexible tube connector 300 connecting two torque tubes 14A, 14B of the solar tracker apparatus 10 as at FIG. 3A, FIG. 3C shows a perspective view of the flexible tube connector 300 in isolation, and FIG. 3D is a cross-sectional view of the flexible tube connector 300 taken along line B-B in FIG. 3C.

The flexible tube connector 300 can be configured to connect two torque tubes 14A, 14B at the solar tracker apparatus 10 at a variety of angular orientations. The flexible tube connector 300 can include a central tube region 302, a first tube end portion 304, and a second tube end portion 306. The first tube end portion 304 can extend out from one end of the central tube region 302, and the second tube end portion 306 can extend out from another, opposite end of the central tube region 302. The flexible tube connector 300 can also include one or more tube flexibility features 310, and at least some (e.g., all) of the tube flexibility features 310 can be located at the central tube region 302. The first tube end portion 304 can include one or more torque tube fastening members, shown here as apertures 305, and the second tube end portion 306 can include one or more torque tube fastening members, shown here as apertures 307. As shown at FIGS. 3A and 3B, one torque tube 14A can be connected to the first tube end portion 304 via the one or more torque tube fastening apertures 305 which can be configured to receive, respectively, a fastening member therethrough and into the torque tube 14A, and the other torque tube 14B can be connected to the second tube end portion 306 via the one or more torque tube fastening apertures 307 which can be configured to receive, respectively, a fastening member therethrough and into the torque tube 14B. And, as shown at FIG. 3B, the central tube region 302, which can include the one or more tube flexibility features 310, can lack any torque tube presence thereat and thus can generally be void at its interior of a torque tube, with the torque tube 14A terminating at its connection to the first tube end portion 304 and distal of the one or more tube flexibility features 310 at the central tube region 302 and with the torque tube 14B terminating at its connection to the second tube end portion 306 and distal of the one or more tube flexibility features 310 at the central tube region 302.

The one or more tube flexibility features 310 can be configured to facilitate a range of angular orientations of the first tube end portion 304 relative to the central tube region 302 and/or a range of angular orientations of the second tube end portion 306 relative to the central tube region 302. And, as such, the one or more tube flexibility features 310 can be configured to facilitate a range of angular orientations between the torque tubes 14A, 14B connected to the flexible tube connector 300. For example, the one or more tube flexibility features 310 at the central tube region 302 of the flexible tube connector 300 can be configured to facilitate movement of the first tube end portion 304, relative to the central tube region 302, in directions 313, and the one or more tube flexibility features 310 at the central tube region 302 of the flexible tube connector 300 can be configured to facilitate movement of the second tube end portion 306, relative to the central tube region 302, in directions 315. Accordingly, the flexible tube connector 300 can be configured to facilitate a connection between torque tubes 14A, 14B across a range of angular orientations between the torque tubes 14A, 14B corresponding to the movement of the first tube end portion 304 in the directions 313 and the movement of the second tube end portion 306 in the directions 315.

As noted, the one or more tube flexibility features 310 can be configured to facilitate a range of angular orientations of the first tube end portion 304 relative to the central tube region 302 and/or a range of angular orientations of the second tube end portion 306 relative to the central tube region 302. The one or more tube flexibility features 310 can take a variety of forms depending on the particular embodiment of the flexible tube connector 300. For example, in the illustrated embodiment, the flexibility features 310 take the form of a series of corrugations at the central tube region 302. For the illustrated embodiment, this series of corrugations at the central tube region 302 includes recessed portions at an outer surface 316 of the central tube region 302 and projections at an inner surface 318 of the central tube region 302. Other embodiments within the scope of this disclosure can include an inverse arrangement where this series of corrugations at the central tube region 302 includes projections at an outer surface 316 of the central tube region 302 and recessed portions at an inner surface 318 of the central tube region 302 or any or a variety of other suitable structural mechanisms at the central tube region 302 configured to allow the end portions 304, 306 to move relative to the central tube region 302. In some such examples, the one or more tube flexibility features 310 can be formed at the central tube region 302 by deforming the central tube region 302 (e.g., by stamping, substrative techniques, etc.). In some embodiments, the flexible tube connector 300 (e.g., including each of the central tube region 302 and the end portions 304, 306) can be made of a composite metallic and/or polymer material suitable to for creating the one or more tube flexibility features 310 and allowing for the described movement of the end portions 304, 306 relative to the central tube region 302.

The one or more tube flexibility features 310 (e.g., in the form of the series of corrugations as in the illustrated embodiment) at the central tube region 302 can extend around some or all of a perimeter (e.g., circumference) of the central tube region 302. As one example, the illustrated embodiment of the flexible tube connector 300 includes the tube flexibility features 310 at some, but not all, of the circumference of the central tube region 302. Namely, the illustrated embodiment of the flexible tube connector 300 includes the tube flexibility features 310 at two spaced apart regions around the circumference of the central tube region 302, with two regions along this circumference, between and spacing apart these two regions having the tube flexibility features 310, lacking the flexibility features 310. The arrangement and extent of the tube flexibility features 310 along the circumference of the central tube region 302 can be varied to achieve a desired degree of movement of the end portions 304, 306 relative to the central tube region 302 as appropriate for a given terrain gradient at a location of the torque tube connection facilitated by the flexible tube connector 300.

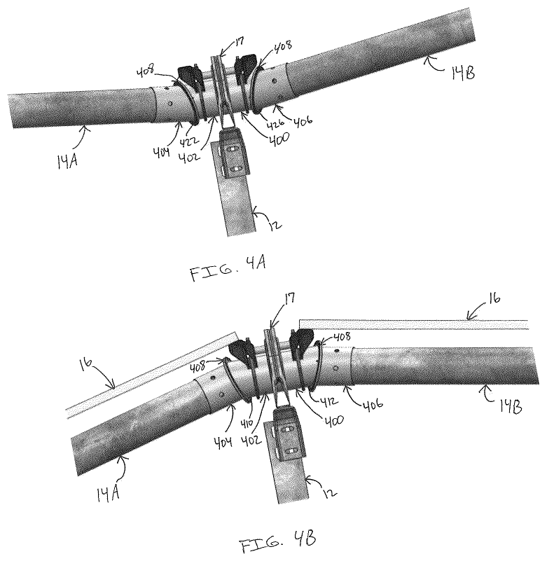

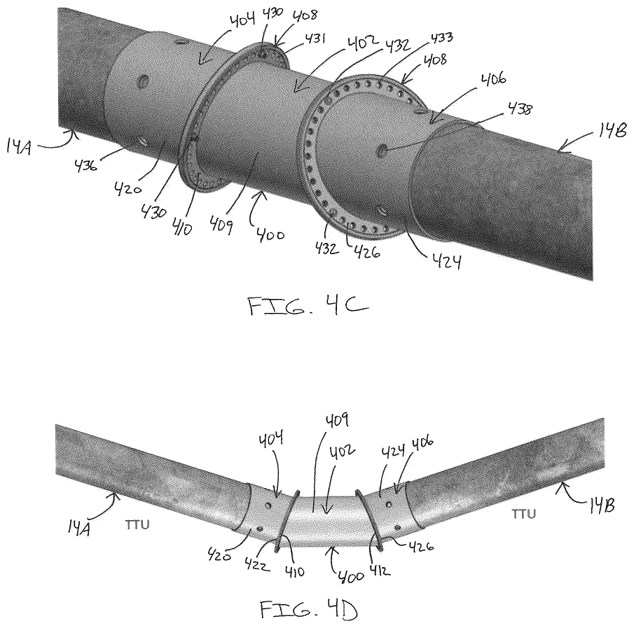

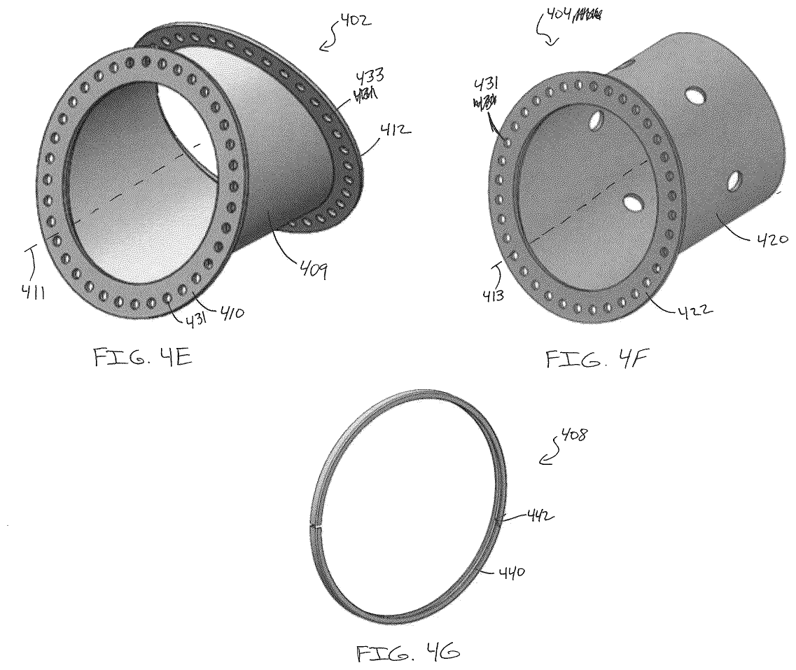

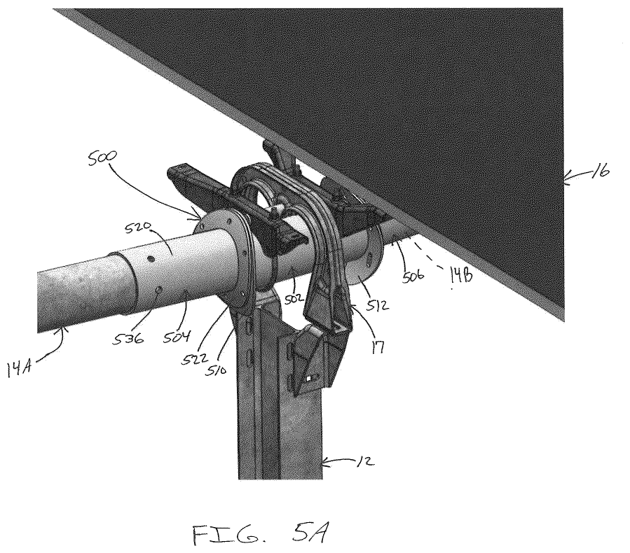

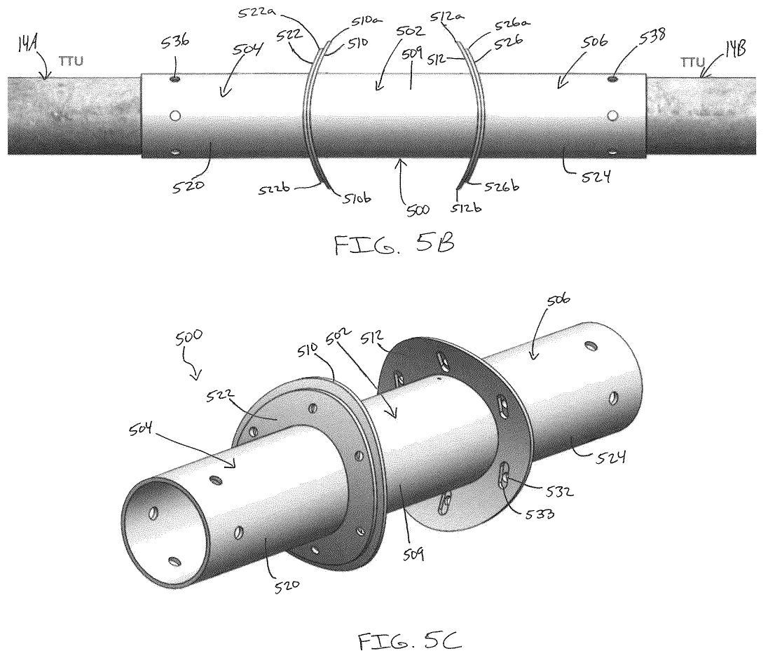

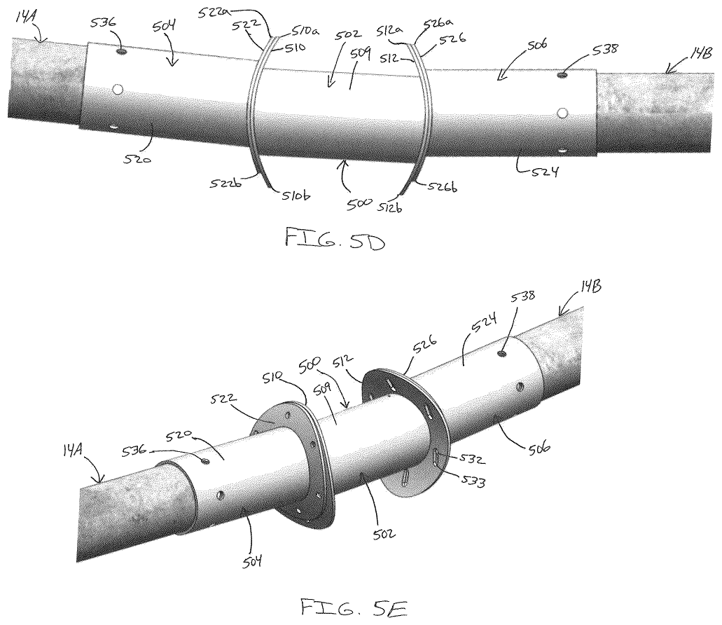

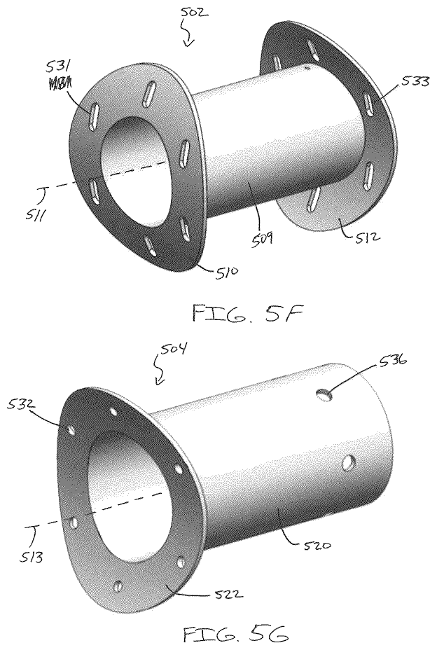

FIGS. 4A-4G illustrate one embodiment of a variable angular orientation tubular connector assembly, and FIGS. 5A-5G illustrate another, different embodiment of a variable angular orientation tubular connector assembly.

As noted, FIGS. 4A-4G illustrate an embodiment of a variable angular orientation tubular connector assembly 400, for instance, for use in connecting two torque tubes 14A, 14B of the solar tracker apparatus 10. FIG. 4A shows an elevational view of the variable angular orientation tubular connector assembly 400 installed to connect two torque tubes 14A, 14B at a first angular orientation, FIG. 4B shows an elevational view of the variable angular orientation tubular connector assembly 400 installed to connect two torque tubes 14A, 14B at a second, different angular orientation, FIG. 4C is a close-up perspective view of the variable angular orientation tubular connector assembly 400 at one angular orientation to connect two torque tubes 14A, 14B in isolation, FIG. 4D is a close-up perspective view of the variable angular orientation tubular connector assembly 400 at another, different angular orientation to connect two torque tubes 14A, 14B in isolation, FIG. 4E is a perspective view of a central tubular connector 402 of the variable angular orientation tubular connector 400, FIG. 4F is a perspective view of a first end connector 404 of the variable angular orientation tubular connector 400 (e.g., with a second end connector 406 having a same configuration as that shown here with respect to the first end connector 404), and FIG. 4G is a perspective view of a guide ring 408 that can be optionally included as a component of the variable angular orientation tubular connector 400.

The variable angular orientation tubular connector assembly 400 can be configured to connect two torque tubes 14A, 14B at the solar tracker apparatus 10 at any of a variety of angular orientations by imparting relative rotation between two or more components of the variable angular orientation tubular connector assembly 400. The variable angular orientation tubular connector assembly 400 can include the central tubular connector 402, the first end connector 404, and the second end connector 406. The central tube connector 402 can include a body 409, a first central tube flange 410, and a second central tube flange 412. The first central tube flange 410 can be located at a first end portion of the body 409 and extend out from the body 409 at that first end portion, and the second central tube flange 412 can be located at a second, opposite end portion of the body 409 and extend out from the body 409 at that second end portion. For example, each of the flanges 410, 412 can define a planar surface (e.g., at each side of each of the flanges 410, 412). The first end connector 404 can include a body 420 and a first end connector flange 422. The first end connector flange 422 can be located at an end portion of the body 420 and extend out from the body 420 at that end portion. Likewise, the second end connector 406 can include a body 424 and a second end connector flange 426. The second connector flange 426 can be located at an end portion of the body 424 and extend out from the body 424 at that end portion. In some examples, as will be apparent from the following description, the first and second end connectors 404, 406 can have the same configuration in isolation and can be installed at opposite orientations at opposite sides of the central tubular connector 402 so as to provide manufacturing an inventor efficiencies.

Each of the first central tube flange 410 and the second central tube flange 412 can be skewed in its orientation relative to a central longitudinal axis 411 of the body 409. For example, each of the first central tube flange 410 and a second central tube flange 412 can extend out from the body 409 at an angle greater than zero degrees and less than ninety degrees relative to the central longitudinal axis 411 of the body 409. In one example, the skewed angle of the first central tube flange 410 can be the same magnitude as the skewed angle of the second central tube flange 412 relative to the central longitudinal axis 411 but of inverse orientations. In other words, when the variable angular orientation tubular connector assembly 400 is assembled, the first central tube flange 410 can angle away from the first end connector 404 in a first direction toward the body 409 at a given angular magnitude relative to the central longitudinal axis 411 and the second central tube flange 412 can angle away from the second end connector 406 in a second, opposite direction toward the body 409 at the same given angular magnitude relative to the central longitudinal axis 411. The flange 422 of the first end connector 404 and the flange 426 of the second end connector 406 can likewise each have the described skewed orientation (e.g., relative to a central longitudinal axis, such as the central longitudinal axis 413 of the body 420) such that the flange 422 can interface with (e.g., flushly contact) the flange 410 of the central tube connector 402 and the flange 426 can interface with (e.g., flushly contact) the flange 412 of the central tube connector 402.

The central tube connector 402 can be configured to connect to the first end connector 404 at the first central tube flange 410 of the central tube connector 402, and the central tube connector 402 can be configured to connect to the second end connector 406 at the second central tube flange 412 of the central tube connector 402. As such, when the variable angular orientation tubular connector assembly 400 is assembled, the first central tube flange 410 can interface with (e.g., contact) the first end connector flange 422 and the second central tube flange 412 can interface with (e.g., contact) the second end connector flange 426. When interfacing, the relative orientation of the first central tube flange 410 and the first end connector flange 422 can define an angular orientation of the first end connector 404 relative to the central tube connector 402. And, when interfacing, the relative orientation of the second central tube flange 412 and the second end connector flange 426 can define an angular orientation of the second end connector 406 relative to the central tube connector 402.

The flanges 410, 412 of the central tube connector 402 and corresponding flanges 422, 426 of the end connectors 404, 406, respectively, can allow for adjusting an angular orientation between the torque tubes 14A, 14B during installation of the variable angular orientation tubular connector assembly 400. For example, imparting relative rotation between the first central tube flange 410 of the central tube connector 402 and the first end connector flange 422 of the first end connector 404 can act to change an angular orientation of the torque tube 14A relative to the pier 12 (e.g., and relative to the torque tube 14B). Similarly, for example, imparting relative rotation between the second central tube flange 412 of the central tube connector 402 and the second end connector flange 426 of the second end connector 406 can act to change an angular orientation of the torque tube 14B relative to the pier 12 (e.g., and relative to the torque tube 14A). Thus, when connecting torque tubes 14A, 14B via the variable angular orientation tubular connector assembly 400 in the field, an installer can hold the central tube connector 402 stationary while rotating each of the first end connector 404, relative to the central tube connector 402, and the second end connector 406, relative to the central tube connector 402, to thereby cause the relative movement between the interfacing flanges 410, 422 and relative movement between the interfacing flanges 412, 426 to, as a result, change the angular orientation between the torque tubes 14A, 14B to be connected via the variable angular orientation tubular connector assembly 400. For instance, the different angular orientations of the torque tube 14A relative to the torque tube 14B, as shown at FIGS. 4C and 4D, can result from different rotational orientations between the interfacing flanges 410, 422 and interfacing flanges 412, 426. Namely, a first relative rotational orientation between each of the interfacing flanges 410, 422 and the interfacing flanges 412, 426 can correspond to, and cause, the angular orientation of the torque tubes 14A, 14B as shown at FIG. 4C, while a second, different relative rotational orientation between each of the interfacing flanges 410, 422 and the interfacing flanges 412, 426 can correspond to, and cause, the different angular orientation of the torque tubes 14A, 14B as shown at FIG. 4D.

Thus, rotational movement between the central tube connector 402 and the interfacing end connectors 404, 406 can be imparted during installation in the field until a desired angular orientation between the torque tubes 14A, 14B is achieved (e.g., an angular orientation between the torque tubes 14A, 14B as suited for a given terrain gradient at the location of the variable angular orientation tubular connector assembly 400 connection of the torque tubes 14A, 14B). Then, when the desired angular orientation between the torque tubes 14A, 14B is achieved, the interfacing flanges 410, 422 can be connected via one or more suitable fastening members 430 inserted at one or more respective fastening apertures 431 that are defined at each of the respective flanges 410, 422 (e.g., as shown at FIG. 4C) and the interfacing flanges 412, 426 can be connected via one or more suitable fastening members 432 inserted at one or more respective fastening apertures 433 that are defined at each of the respective flanges 412, 426 (e.g., as shown at FIG. 4C). In addition, the first end connector 404 can be connected to the torque tube 14A via one or more torque tube fastening apertures 436 at the first end connector 404, and the second end connector 406 can be connected to the torque tube 14B via one or more torque tube fastening apertures 438 at the second end connector 406.

In some embodiments, the central tube connector 402 and/or the respective interfacing end connector 404, 406 can include one or more visual indicators thereat, with such one or more visual indicators corresponding to present angular orientations of one or more torque tubes that will result from an orientation corresponding to that visual indicator. For example, at least one of the interfacing flanges 410, 422 can include a plurality of visual indicators each corresponding to a different angular orientation of the torque tube 14A connected thereat resulting from alignment of the interfacing flanges 410, 422 at the given visual indicator. Likewise, at least one of the interfacing flanges 412, 426 can include a plurality of visual indicators each corresponding to a different angular orientation of the torque tube 14B connected thereat resulting from alignment of the interfacing flanges 412, 426 at the given visual indicator. Alternatively or additionally, such visual indicators could be included corresponding to the relative angular orientation between the torque tubes 14a, 14B resulting from each of a plurality of interfacing flange 410, 422 and 412, 426 rotational orientations so as to provide the installer with an indication of the relative angular orientation between the torque tubes 14A, 14B that will result from the rotational orientation of the flanges 410, 422, and 412, 426 at that given rotational orientation thereof corresponding to the particular visual indicator.

In some cases, it can be helpful to temporarily hold the rotational orientation of the interfacing flanges 410, 422 and/or to temporarily hold the rotational orientation of the interfacing flanges 412, 426 during installation of the variable angular orientation tubular connector assembly 400. As one example, to help hold the rotational orientation of the interfacing flanges 410, 422 a guide ring 408 can be placed at the interfacing location of the flanges 410, 422 to help hold the imparted, desired rotational orientation between the interfacing flanges 410, 422 (e.g., until this rotational orientation is fixed via fastening member(s) 430). Likewise, in such one example, to help hold the rotational orientation of the interfacing flanges 412, 426 another guide ring 408 can be placed at the interfacing location of the flanges 412, 426 to help hold the imparted, desired rotational orientation between the interfacing flanges 412, 426 (e.g., until this rotational orientation is fixed via fastening member(s) 432). FIG. 4G illustrates an exemplary embodiment of such guide ring 408. The guide ring 408 can include (e.g., at an interior surface 440) a complementary connector 442 that in configured to be received between the interfacing flanges 410, 422 (or 412, 426 as the case may be), and this insertion of the complementary connector 442 thereat can act to hold the relative rotational orientation between the interfacing flanges 410, 422 (or 412, 426 as the case may be). Then, once the variable angular orientation tubular connector assembly 400 is fixed to cause the desired angular orientation between the torque tubes 14A, 14B, the guide ring 408 could be removed (or, in an alternate example, the guide ring 408 can be left in place at the interfacing flanges to help provide additional rotational fixational stability between the interfacing flanges).

5A-5G illustrate another embodiment of a variable angular orientation tubular connector assembly 500. The variable angular orientation tubular connector assembly 500 can be configured to perform the same function as the variable angular orientation tubular connector assembly 400 described previously herein, but with the variable angular orientation tubular connector assembly 500 configured to adjust the angular orientation between torque tubes 14A, 14B via imparted translation (e.g., sliding) between interfacing flanges, as opposed to via imparted rotation between interfacing flanges as with the variable angular orientation tubular connector assembly 400. FIG. 5A shows a perspective view of the variable angular orientation tubular connector assembly 500 installed to connect two torque tubes 14A, 14B at a first angular orientation, FIG. 5B is an elevational view of the variable angular orientation tubular connector assembly 500 connecting the two torque tubes 14A, 14B at the first angular orientation as in FIG. 5A, FIG. 5C is a perspective view of the variable angular orientation tubular connector assembly 500 in isolation at the first angular orientation, FIG. 5D is an elevational view of the variable angular orientation tubular connector assembly 500 connecting the two torque tubes 14A, 14B at a second, different angular orientation, FIG. 5E is a perspective view of the variable angular orientation tubular connector assembly 500 connecting the two torque tubes 14A, 14B at the second, different angular orientation as in FIG. 5D, FIG. 5F is a perspective view of a central tubular connector 502 of the variable angular orientation tubular connector 500, and FIG. 5G is a perspective view of an end connector component 504 (e.g., or 506) of the variable angular orientation tubular connector assembly 500.

The variable angular orientation tubular connector assembly 500 can be configured to connect two torque tubes 14A, 14B at the solar tracker apparatus 10 at any of a variety of angular orientations by imparting relative movement (e.g., translation) between two or more components of the variable angular orientation tubular connector assembly 500. The variable angular orientation tubular connector assembly 500 can include the central tubular connector 502, the first end connector 504, and the second end connector 506. The central tube connector 502 can include a body 509, a first central tube flange 510, and a second central tube flange 512. The first central tube flange 510 can be located at a first end portion of the body 509 and extend out from the body 509 at that first end portion, and the second central tube flange 512 can be located at a second, opposite end portion of the body 509 and extend out from the body 509 at that second end portion. The first end connector 504 can include a body 520 and a first end connector flange 522. The first end connector flange 522 can be located at an end portion of the body 520 and extend out from the body 520 at that end portion. Likewise, the second end connector 506 can include a body 524 and a second end connector flange 526. The second connector flange 526 can be located at an end portion of the body 524 and extend out from the body 524 at that end portion. In some examples, as will be apparent from the following description, the first and second end connectors 504, 506 can have the same configuration in isolation and can be installed at opposite orientations at opposite sides of the central tubular connector 502 so as to provide manufacturing an inventor efficiencies.

Each of the first central tube flange 510 and the second central tube flange 512 can be curved, and each of the first end connector flange 522 and the second connector flange 526 can likewise be curved. For instance, the curvature of the first central tube flange 510 can include a radius of curvature that is the same as a radius of curvature included at the first end connector flange 522, and the curvature of the second central tube flange 512 can include a radius of curvature that is the same as a radius of curvature included at the second end connector flange 526. For the illustrated embodiment, the flanges 510, 512 of the central tube connector 502 have an outward-most (or can be referred to as distal-most) flange portion generally at a central longitudinal axis 511 of the body 509 with the flanges 510, 512 of the central tube connector 502 curving back inward toward the body 509 as each of the flanges 510, 512 progresses radially outward from the central longitudinal axis 511. And, for the illustrated embodiment, the flange 522 of the first end connector 504 and the flange 526 of the second end connector can define flange curvature that is complementary to (e.g., matches) the flange curvature of the flanges 510, 512, respectively. Namely, for the illustrated embodiment, the flange 522 can have an inward-most (or can be referred to as proximal-most) flange portion generally at a central longitudinal axis 513 of the body 520 (e.g., shown at FIG. 5G) with the flange 522 of the first end connector 504 curving away the body 520 as the flange 522 progresses radially outward from the central longitudinal axis 513. And the flange 526 of the second end connector 506 can likewise have an inward-most (or can be referred to as proximal-most) flange portion generally at a central longitudinal axis of the body 524 with the flange 526 of the second end connector 506 curving away the body 524 as the flange 526 progresses radially outward from the central longitudinal axis of the body 524.

The flange 510 at the central tube connector 502 can have a length (e.g., in a radial direction normal to the central longitudinal axis 511) that is greater than a length of the flange 522 of the first end connector 504, and the flange 512 at the central tube connector 502 can have a length (e.g., in a radial direction normal to the central longitudinal axis 511) that is greater than a length of the flange 526 of the second end connector 506. While the length of the flanges 510, 512 can be longer than the length of the respective interfacing flanges 522, 526, the magnitude of the length of the flanges 510, 512 can be varied as suited for the particular terrain gradient application. For example, the longer the length of the flanges 510, 512, the greater the maximum skewed, angular orientation of the respective end connector 504, 506 relative to central tube connector 502 can be. As such, for relatively high gradient terrain applications, relatively longer flanges 510, 512 can be used.

The central tube connector 502 can be configured to connect to the first end connector 504 at the first central tube flange 510 of the central tube connector 502, and the central tube connector 502 can be configured to connect to the second end connector 506 at the second central tube flange 512 of the central tube connector 502. As such, when the variable angular orientation tubular connector assembly 500 is assembled, the first central tube flange 510 can interface with (e.g., contact) the first end connector flange 522 and the second central tube flange 512 can interface with (e.g., contact) the second end connector flange 526. When interfacing, the relative orientation of the first central tube flange 510 and the first end connector flange 522 can define an angular orientation of the first end connector 504 relative to the central tube connector 502. And, when interfacing, the relative orientation of the second central tube flange 512 and the second end connector flange 526 can define an angular orientation of the second end connector 506 relative to the central tube connector 502.

The flanges 510, 512 of the central tube connector 502 and corresponding flanges 522, 526 of the end connectors 504, 506, respectively, can allow for adjusting an angular orientation between the torque tubes 14A, 14B during installation of the variable angular orientation tubular connector assembly 500. For example, imparting relative translation (e.g., sliding) between the first central tube flange 510 of the central tube connector 502 and the first end connector flange 522 of the first end connector 504 can act to change an angular orientation of the torque tube 14A relative to the pier 12 (e.g., and relative to the torque tube 14B). Similarly, for example, imparting relative translation (e.g., sliding) between the second central tube flange 512 of the central tube connector 502 and the second end connector flange 526 of the second end connector 506 can act to change an angular orientation of the torque tube 14B relative to the pier 12 (e.g., and relative to the torque tube 14A). Thus, when connecting torque tubes 14A, 14B via the variable angular orientation tubular connector assembly 500 in the field, an installer can impart relative translation between the flange 510 of the central tube connector 502 and the flange 522 of the first end connector 504 to correspondingly change the angular orientation between the first end connector 504 and the central tube connector 502, and thus change the angular orientation of the torque tube 14A connected, or to be connected, at the first end connector 504. Similarly, an installer can impart relative translation between the flange 512 of the central tube connector 502 and the flange 526 of the second end connector 506 to correspondingly change the angular orientation between the second end connector 506 and the central tube connector 502, and thus change the angular orientation of the torque tube 14B connected, or to be connected, at the second end connector 506.

Accordingly, by changing the relative radial positioning (e.g., relative positioning between flanges 510, 522 in the direction normal to the central longitudinal axis 511) of the interfacing flanges 510, 522, the angular orientation of the torque tube 14A can be correspondingly changed, and by changing the relative radial positioning (e.g., relative positioning between flanges 512, 526 in the direction normal to the central longitudinal axis 511) of the interfacing flanges 512, 526, the angular orientation of the torque tube 14B can be correspondingly changed. As a result, a desired angular orientation between torque tubes 14A, 14B as suited for a terrain gradient at a given installation location can be achieved by imparting an appropriate degree of translation between the interfacing flanges 510, 522 and by imparting an appropriate degree of translation between the interfacing flanges 512, 526. By changing the relative radial positioning of the interfacing flanges 510, 522 and/or 512, 526, the angular orientation between torque tubes 14A, 14B can be changed.

For instance, the angular orientation between torque tubes 14A, 14B as shown at the example of FIGS. 5B and 5C can result from a first relative radial positioning of the interfacing flanges 510, 522 and a first relative radial positioning of the interfacing flanges 512, 526. And, the different angular orientation between torque tubes 14A, 14B as shown at the example of FIGS. 5D and 5E can result from a second, different relative radial positioning of the interfacing flanges 510, 522 and/or a second, different relative radial positioning of the interfacing flanges 512, 526. Namely, as seen at the example of FIGS. 5B and 5C having the first angular orientation between torque tubes 14A, 14B, an upper end portion 522a of the flange 522 is radially offset relative to an upper end portion 510a of the flange 510, and a lower end portion 522b of the flange 522 is radially offset relative to a lower end portion 510b of the flange 510. Likewise, as seen at the example of FIGS. 5B and 5C having the first angular orientation between torque tubes 14A, 14B, an upper end portion 526a of the flange 526 is radially offset relative to an upper end portion 512a of the flange 512, and a lower end portion 526b of the flange 526 is radially offset relative to a lower end portion 512b of the flange 512. Yet, as seen at the example of FIGS. 5D and 5E having the second, different angular orientation between torque tubes 14A, 14B, the upper end portion 522a of the flange 522 is generally aligned in the radial direction with the upper end portion 510a of the flange 510, while the lower end portion 522b of the flange 522 is radially offset to a greater degree, relative to the lower end portion 510b of the flange 510, than for the first angular orientation shown at FIGS. 5B and 5C. Likewise, as seen at the example of FIGS. 5D and 5E having the second, different angular orientation between torque tubes 14A, 14B, an upper end portion 526a of the flange 526 is generally aligned in the radial direction with the upper end portion 512a of the flange 512, and a lower end portion 526b of the flange 526 is radially offset to a greater degree, relative to the lower end portion 512b of the flange 512, than for the first angular orientation shown at FIGS. 5B and 5C. As such, in this example, by translating the central tube connector 502 relative to the end connectors 504, 506 in a downward direction so as to change relative radial positioning between the interfacing flanges 510, 512 and between interfacing flanges 512, 526, the angular orientation between torque tubes 14A, 14B can be changed from that shown at FIGS. 5B, 5C to that shown at FIGS. 5D, 5E. In other examples, the direction (e.g., radially up or radially down), and magnitude, of imparted translation between the central tube connector 502 and one or both of the end connectors 504, 506 can be adjusted to achieve a desired angular orientation between torque tubes 14A, 14B as suited for a given terrain gradient at a given local installation location.

When the desired angular orientation between the torque tubes 14A, 14B is achieved, the interfacing flanges 510, 522 can be connected via one or more suitable fastening members inserted at one or more respective fastening slots 531 (e.g., elongated, in the radial direction, slots so as to provide a range of alignment locations) that are defined at the flange 510 and at one or more aligned fastening apertures 532 that are defined at the flange 522. And the interfacing flanges 512, 526 can be connected via one or more suitable fastening members inserted at one or more respective fastening slots 533 (e.g., elongated, in the radial direction, slots so as to provide a range of alignment locations) that are defined at the flange 512 and at one or more aligned fastening apertures 532 that are defined at the flange 526. In addition, the first end connector 504 can be connected to the torque tube 14A via one or more torque tube fastening apertures 536 at the first end connector 504, and the second end connector 506 can be connected to the torque tube 14B via one or more torque tube fastening apertures 538 at the second end connector 506.

As described previously herein, the central tube connector 502 and/or the respective interfacing end connector 504, 506 can include one or more visual indicators thereat, with such one or more visual indicators corresponding to present angular orientations of one or more torque tubes that will result from an orientation corresponding to that visual indicator. For example, at least one of the interfacing flanges 510, 522 can include a plurality of visual indicators each corresponding to a different angular orientation of the torque tube 14A connected thereat resulting from various radial alignments of the interfacing flanges 510, 522 corresponding to, respectively, the various visual indicators. Likewise, at least one of the interfacing flanges 512, 526 can include a plurality of visual indicators each corresponding to a different angular orientation of the torque tube 14B connected thereat resulting from various radial alignments of the interfacing flanges 512, 526 corresponding to, respectively, the various visual indicators.

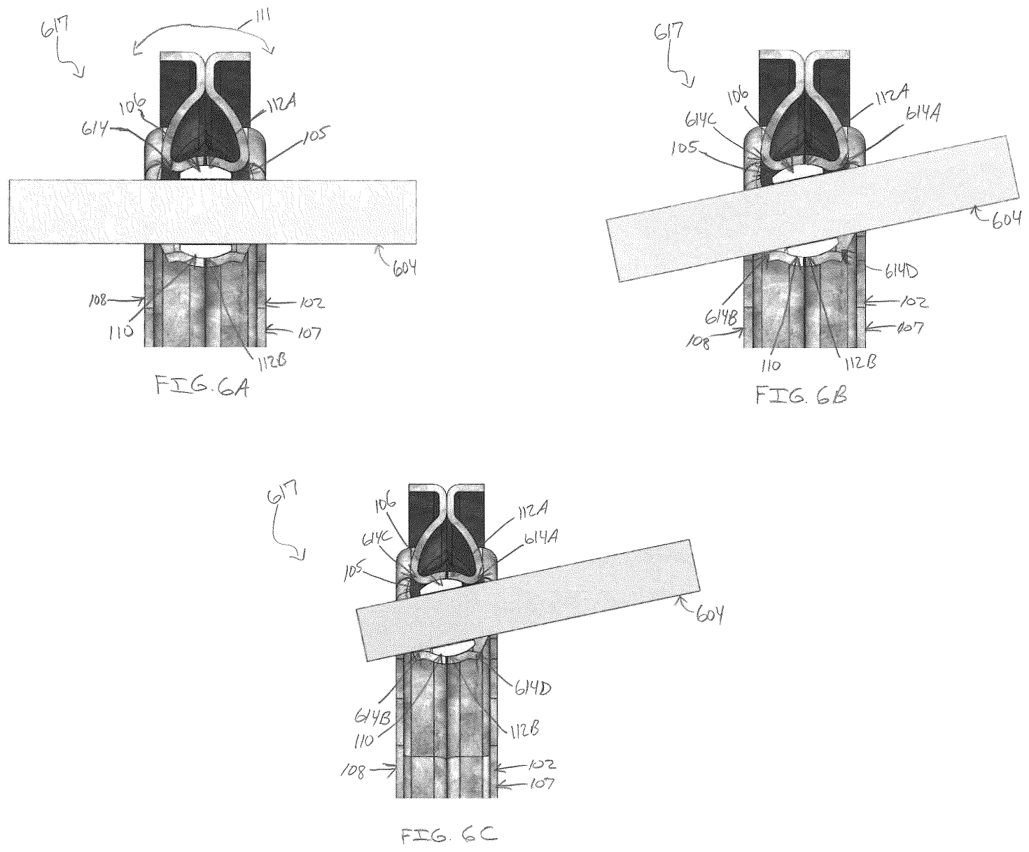

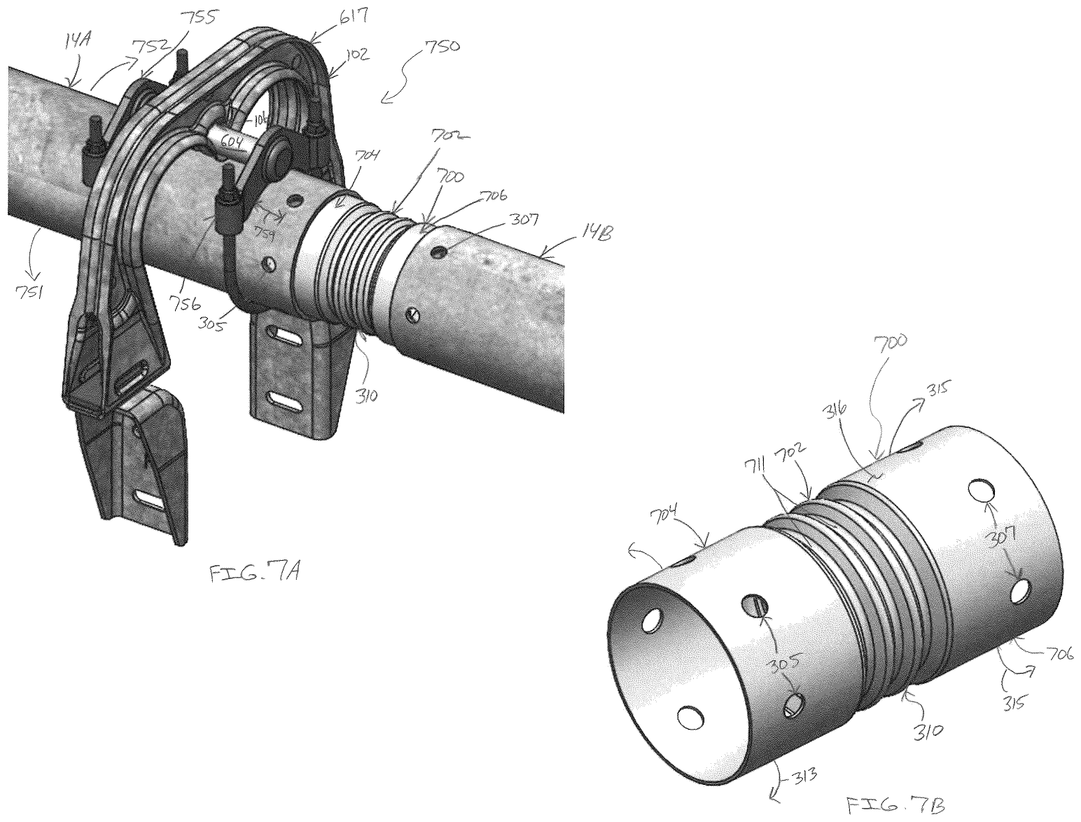

FIGS. 6A-6C illustrate another embodiment of a bearing housing assembly 617. The bearing housing assembly 617 can, for instance, be configured to facilitate solar tracker installation at relatively high gradient terrain. The bearing housing assembly 617 can be similar to, or the same as, the bearing housing assembly 17 illustrated and described in reference to FIGS. 2A-2G except as otherwise illustrated or described here in reference to FIGS. 6A-6C. As such, like reference characters are used to denote like elements. More specifically, the bearing housing assembly 617 can have a different structural configuration for the interference stops 614A, 614B, 614C, 614D as compared to the structural configuration for the interference stops 114A, 114B, 114C, 114D of the bearing housing assembly 17 but can otherwise be configured similarly, or the same, and operable to function in a similar, or same, manner.

FIGS. 6A-6C illustrate the bearing housing assembly 617 similar to that illustrated and described for the bearing housing assembly 17 at FIG. 2E-2G. Namely, FIG. 6A is a cross-sectional view showing a pin 604 at a horizontal angular orientation, FIG. 6B is a cross-sectional view showing the pin 604 at a skewed angular orientation between horizontal and vertical, and FIG. 6C is a cross-sectional view showing the pin 604 at the skewed angular orientation between horizontal and vertical as in FIG. 6B but also showing the pin 604 translated.

The cradle 110 of the bearing housing assembly 617 can be configured to provide one or more interference stops 614 to limit the upper bounds of the pivotable movement of the pin 604 relative to the bearing housing 102. For example, the cradle 110 can define a first interference stop 614A at one, upper side end portion of the pin aperture 105 (e.g., at an upper side end portion of the pin aperture at the first hoop 107) and a second interference stop 614B at an opposite, lower side end portion of the pin aperture 105 (e.g., at a lower side end portion of the pin aperture at the second hoop 108). The first and second first interference stops 614A, 614B can be configured to limit the extent of rotation of the pin 104 in one direction 111 (e.g., to the left at the illustrated orientation) relative the bearing housing 102. The cradle 110 can further define a third interference stop 614C at one, upper side end portion of the pin aperture 105 (e.g., at an upper side end portion of the pin aperture at the second hoop 108) and a fourth interference stop 614D at an opposite, lower side end portion of the pin aperture 105 (e.g., at a lower side end portion of the pin aperture at the first hoop 107). The third and fourth first interference stops 614C, 614D can be configured to limit the extent of rotation of the pin 104 in another direction 111 relative the bearing housing 102 (e.g., in a direction 111, relative to the bearing housing 102, that is opposite the direction which the first and second interference stops 614A, 614B limit the extent of rotation of the pin 604; to the right at the illustrated orientation). Yet, in addition to including the one or more interference stops 614, the cradle 110 can also be configured to retain the ring 106 at the bearing housing 102 such that the ring 106 can rotate relative to the bearing housing 102 while the cradle maintains the ring 106 at the bearing housing 102.

In the illustrated embodiment, the pin 604 can also be configured to translate relative to ring 106, and thus relative to the bearing housing 102. For example, a cross sectional shape of an interior surface 120 of the ring 106 (shown, e.g., at FIG. 2D) can generally match a cross-sectional shape of an exterior surface 103 of the pin 604. In this way, when the pin 604 is received at the interior surface 120 of the ring 106, the pin 604 can be configured to slide in directions 113, relative to the ring 106, that are generally radial relative to the bearing housing 102.

The ability of the bearing housing assembly 617 to facilitate pivoting and/or translation of the pin 604, via the ring 106, can be useful in accommodating different angles of torque tube connections at variable terrain gradients. FIGS. 6A-6C show the cross-sectional views with the pin 604 moved relative to the bearing housing 102 to various exemplary positions. In particular, FIG. 6A shows the pin 604 generally at a horizontal angular orientation relative to the bearing housing 102 (e.g., the pin 604 extends generally parallel to the longitudinal axis of the pin aperture 105 at the bearing housing 102). FIG. 6B shows the pin 604 pivoted relative to the bearing housing 102 such that the pin 604 is at a skewed angular orientation between horizontal and vertical relative to the bearing housing 102 (e.g., the pin 604 extends through the pin aperture 105 at a skewed angle relative to the longitudinal axis of the pin aperture 105). And FIG. 6C shows the pin 604 at the pivot location of FIG. 6B but with the pin 604 now translated, in a direction toward the hoop 107, relative to the ring 106 and the bearing housing assembly 102 (e.g., such that the pin 604 projects further out from the pin aperture 105 from the hoop 107 side of the bearing housing 102 than from the hoop 108 side of the bearing housing 102). As with the bearing housing assembly 17 embodiment illustrated and described at FIGS. 2E-2G, the bearing housing assembly 617 embodiment illustrated and described at FIG. 6A-6C can be configured to limit a range of rotation of the pin 604 via the inclusion of the interference stops 614A-614D that can be configured to contact, and thereby prevent further rotation of, the pin 604.

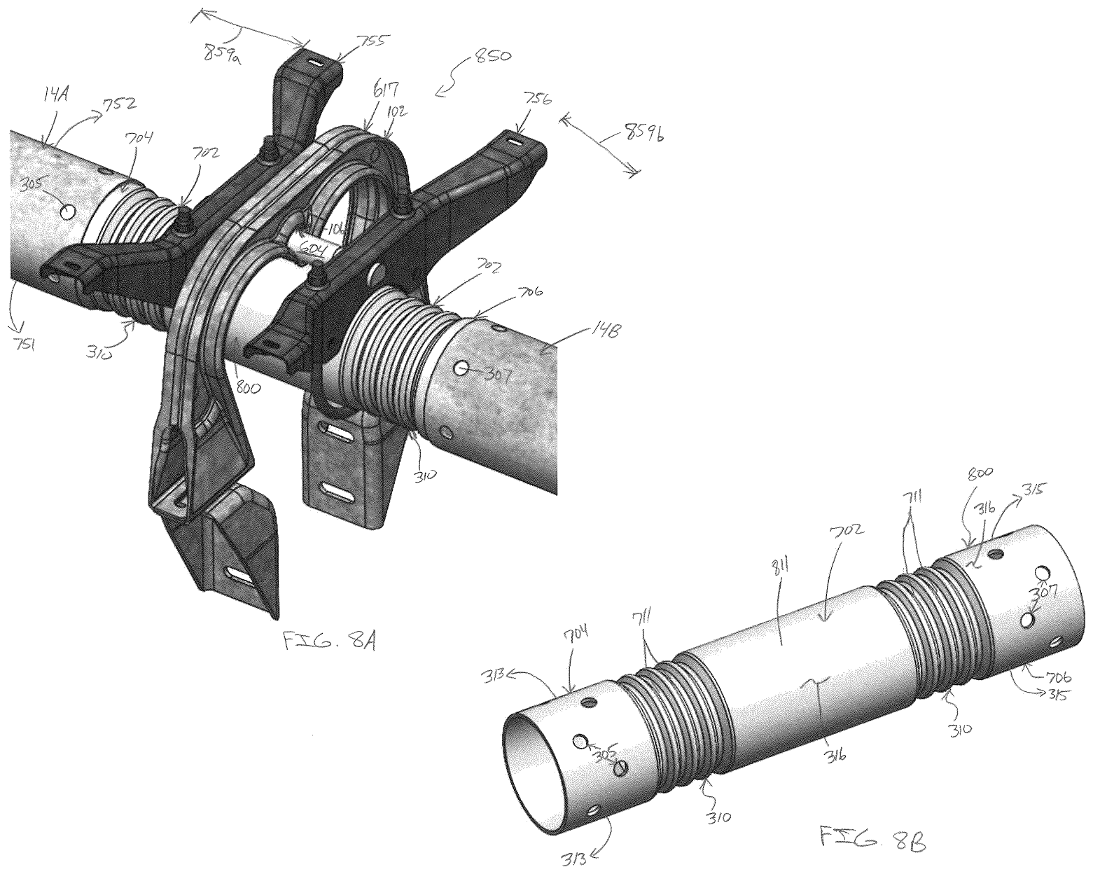

One embodiment of a flexible tube connector was previously illustrated and described in reference to FIGS. 3A-3D. FIGS. 7A-11D illustrate additional embodiments of flexible tube connectors that will be described as follows in reference to FIGS. 7A-11D. The additional embodiments of flexible tube connectors can be similar to, or the same as, that disclosed previously in reference to FIGS. 3A-3D except as otherwise noted as follows. Thus, like reference characters are used to denote like elements.

FIGS. 7A-7B illustrate another embodiment of a flexible tube connector 700. FIG. 7A is a perspective view of a system 750 that includes the flexible tube connector 700 and the bearing housing assembly 617 configured for rotatably connecting two torque tubes 14A, 14B of a solar tracker (e.g., solar tracker apparatus 10). In particular, the flexible tube connector 700 can be configured to rotatably connect two torque tubes 14A, 14B of a solar tracker such that the torque tubes 14A, 14B can be rotatably supported by, and rotate relative to, the bearing housing 102 in both first direction 751 and in second, opposite direction 752. For instance, as torque tube 14A is rotatably driven by the solar tracker apparatus, the flexible tube connector 700 can act to rotatably connect the torque tube 14B to the torque tube 14A such that the torque tube 14B is caused to rotate with the torque tube 14A. FIG. 7B is a perspective view of the flexible tube connector 700 in isolation.

The flexible tube connector 700 can be configured to rotatably connect torque tubes 14A, 14B at a solar tracker apparatus at a variety of angular orientations (e.g., at a plurality of angular orientations relative to the bearing housing 102). The flexible tube connector 700 can include a central tube region 702, a first tube end portion 704, a second tube end portion 706, and one or more flexibility features 310. Some or all of the flexibility features 310 can be located at the central tube region 702. The first tube end portion 704 can extend out from one end of the central tube region 702, and the second tube end portion 706 can extend out from another, opposite end of the central tube region 702. As seen at FIG. 7A, the first tube end portion 704 can be configured to couple to a torque tube 14A and the second tube end portion 706 can be configured to couple to torque tube 14B.

To help facilitate coupling the first and second tube end portions 704, 706 to the respective torque tubes 14A, 14B, each of the first and second tube end portions 704, 706 can include one or more fastening features. As show for the illustrated embodiment of the flexible tube connector 700, the first tube end portion 704 can include one or more torque tube fastening members, shown here as apertures 305, and the second tube end portion 706 can include one or more torque tube fastening members, shown here as apertures 307. One torque tube 14A can be connected to the first tube end portion 704 via the one or more torque tube fastening apertures 305 which can be configured to receive, respectively, a fastening member therethrough and into the torque tube 14A, and the other torque tube 14B can be connected to the second tube end portion 706 via the one or more torque tube fastening apertures 307 which can be configured to receive, respectively, a fastening member therethrough and into the torque tube 14B. For instance, torque tube 14A and torque tube 14B can each include complementary fastening apertures that can be aligned with the fastening apertures 305, 307 for inserting a fastening member (e.g., bolt, rivet, etc.) therethrough. The illustrated embodiment of the flexible tube connector 700 can have the end portions 704, 706 with an outer diameter that is configured to sit (e.g., next) within the respective interfacing end portion of the torque tubes 14A, 14B. For some embodiments of the flexible tube connector 700, the central tube region 702, which can include the one or more tube flexibility features 310, can be configured to lack any torque tube 14A, 14B presence thereat and thus can generally be void at its interior of a torque tube 14A or 14B, with the torque tube 14A terminating at or near its connection to the first tube end portion 704 and distal of the one or more tube flexibility features 310 at the central tube region 702 and with the torque tube 14B terminating at its connection to the second tube end portion 706 and distal of the one or more tube flexibility features 310 at the central tube region 702.

The one or more tube flexibility features 310 can be configured to facilitate a range of angular orientations of the first tube end portion 704 relative to the central tube region 702 and/or a range of angular orientations of the second tube end portion 706 relative to the central tube region 702. As such, the one or more tube flexibility features 310 can be configured to facilitate a range of angular orientations between the torque tubes 14A, 14B connected to the flexible tube connector 700 such that the one or more tube flexibility features 310 can be configured to cause the first tube end portion 704 to connect to the torque tube 14A and the second tube end portion 706 to connect to the torque tube 14B at a plurality of angular orientations, such as suited for the particular terrain gradient. For example, the one or more tube flexibility features 310 at the central tube region 702 of the flexible tube connector 700 can be configured to facilitate movement of the first tube end portion 704, relative to the central tube region 702, in directions 313, and the one or more tube flexibility features 310 at the central tube region 702 of the flexible tube connector 700 can be configured to facilitate movement of the second tube end portion 706, relative to the central tube region 702, in directions 315. Accordingly, in some cases, the flexible tube connector 700 can be configured to facilitate a connection between torque tubes 14A, 14B across a range of angular orientations between the torque tubes 14A, 14B corresponding to the movement of the first tube end portion 704 in the directions 313 and the movement of the second tube end portion 706 in the directions 315. As shown for the illustrated embodiment, the one or more tube flexibility features 310 can be located between the one or more torque tube fastening apertures 305 at the first tube end portion 704 and the one or more torque tube fastening apertures 307 at the second tube end portion 706.

As noted, the one or more tube flexibility features 310 can be configured to cause the first tube end portion 704 to connect to the torque tube 14A at a plurality of angular orientations relative to the central tube region 702, and the one or more flexibility features 310 can be configured to cause the second tube end portion 706 to connect to the torque tube 14B at a plurality of angular orientations relative to the central tube region 702. The one or more tube flexibility features 310 can take a variety of forms depending on the particular embodiment of the flexible tube connector 700. For example, the illustrated embodiment shows the flexibility features 310 in the form of a series of corrugations at the central tube region 702. More specifically, the illustrated embodiment at FIGS. 7A and 7B shows this series of corrugations at the central tube region 702 as including a plurality of recessed portions 711 at an outer surface 316 of the central tube region 702. As illustrated here, the plurality of recessed portions 711 can be spaced apart from one another along at least a portion of a length of the central tube region 702. As also illustrated here, each of the plurality of recessed portions 711 can extend around an entire perimeter of the outer surface 316 at a given longitudinal location of the recessed portion 711 along the length of the central tube region 702. The inclusion of such plurality of recessed portions 711 can act to increase the flexibility of the flexible tube connector 700 to help accommodate a plurality of different angular orientations between the first and second tube end portions 704, 706 and the central tube portion 702.

FIG. 7A illustrates the flexible tube connector 700 applied to rotatably connect together torque tubes 14A, 14B for the system 750. As noted, system 750 can include the flexible tube connector 700 and the bearing housing assembly 617 configured for rotatably connecting two torque tubes 14A, 14B of a solar tracker. In particular, the flexible tube connector 700 can be configured to rotatably connect two torque tubes 14A, 14B of a solar tracker such that the torque tubes 14A, 14B can be rotatably supported by, and rotate relative to, the bearing housing 102 of the bearing housing assembly 617 in both first direction 751 and in second, opposite direction 752. As seen at FIG. 7A, the pin 604 of the bearing housing assembly 617 can be received at the rotatable ring 106 such that the pin 604 is spaced apart from, and above (e.g., the pin is at a greater elevation above ground surface than the flexible tube connector 700), the flexible tube connector 700.

In addition to the flexible tube connector 700 and the bearing housing assembly 617, the system 750 can further include a first rail 755 and a second rail 756. As shown for the example at FIG. 7A, the first rail 755 can be coupled to the pin 604 at a first side of the housing 102 and the second rail 756 can be coupled to the pin 604 at a second, opposite side of the housing 102. The first rail 755 can be configured to couple to one of the torque tube 14A and the central tube region 702 to rotatably support the torque tube 14A, and the second rail 756 can be configured to couple to one of the torque tube 14B and the central tube region 702 to rotatably support the torque tube 14B. When the flexible tube connector 700 is applied to rotatably connect together torque tubes 14A, 14B for the system 750, such as shown at FIG. 7A, the first tube end portion 704 can have the one or more torque tube fastening apertures 305 at a location along the first tube end portion 704 longitudinally offset from a first end of the pin 604 a distance 759, and the second tube end portion 706 can have the one or more torque tube fastening apertures 307 at a location along the second tube end portion 706 longitudinally offset from the first end of the pin 604 more than the distance 759.

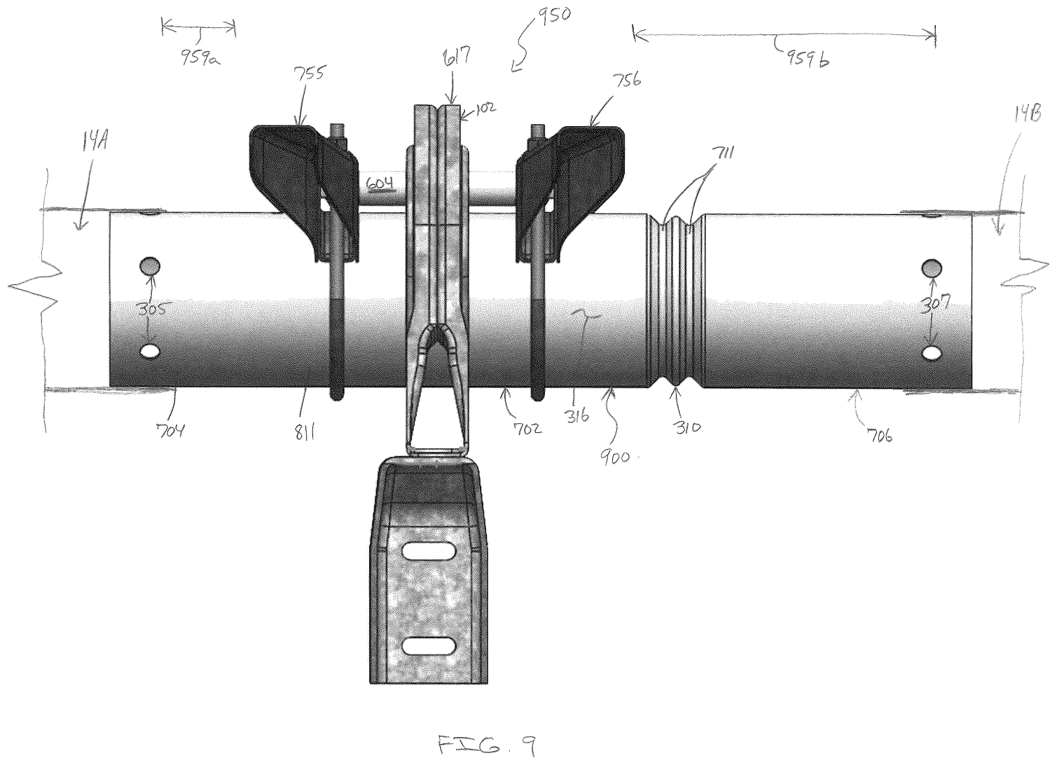

FIGS. 8A-8B illustrate another embodiment of a flexible tube connector 800. FIG. 8A is a perspective view of a system 850 that includes the flexible tube connector 800 and the bearing housing assembly 617 configured for rotatably connecting two torque tubes 14A, 14B of a solar tracker (e.g., solar tracker apparatus 10). In particular, the flexible tube connector 800 can be configured to rotatably connect two torque tubes 14A, 14B of a solar tracker such that the torque tubes 14A, 14B can be rotatably supported by, and rotate relative to, the bearing housing 102 in both first direction 751 and in second, opposite direction 752. For instance, as torque tube 14A is rotatably driven by the solar tracker apparatus, the flexible tube connector 800 can act to rotatably connect the torque tube 14B to the torque tube 14A such that the torque tube 14B is caused to rotate with the torque tube 14A. FIG. 8B is a perspective view of the flexible tube connector 800 in isolation.

Except as otherwise illustrated and noted as follows, the flexible tube connector 800 can be as disclosed previously in reference to the flexible tube connector 700 at FIGS. 7A and 7B. Namely, the flexible tube connector 800 can be configured to rotatably connect torque tubes 14A, 14B at a solar tracker apparatus at a variety of angular orientations (e.g., at a plurality of angular orientations relative to the bearing housing 102). The flexible tube connector 800 can include the central tube region 702, the first tube end portion 704, and the second tube end portion 706. As seen at FIG. 8A, the first tube end portion 704 can be configured to couple to a torque tube 14A and the second tube end portion 706 can be configured to couple to torque tube 14B. One torque tube 14A can be connected to the first tube end portion 704 via the one or more torque tube fastening apertures 305 which can be configured to receive, respectively, a fastening member therethrough and into the torque tube 14A, and the other torque tube 14B can be connected to the second tube end portion 706 via the one or more torque tube fastening apertures 307 which can be configured to receive, respectively, a fastening member therethrough and into the torque tube 14B.

In addition, the flexible tube connector 800 as illustrated at FIGS. 8A and 8B can include at least two flexibly features 310. As described previously, the at least two tube flexibility features 310 can be configured to cause the first tube end portion 704 to connect to the torque tube 14A at a plurality of angular orientations relative to the central tube region 702, and the one or more flexibility features 310 can be configured to cause the second tube end portion 706 to connect to the torque tube 14B at a plurality of angular orientations relative to the central tube region 702. The at least two flexibility features 310 can be located at the central tube region 702. For example, the central tube region 702, of the illustrated embodiment of the flexible tube connector 800, can include a non-corrugated region 811 and the at least two flexibility features 310. The non-corrugated region 811 can define a constant diameter along a length of the outer surface 316 of the central tube region 702. For instance, as illustrated, the non-corrugated region 811 can extend along a portion of the length of the central tube region 702, and the non-corrugated region 811 can be bounded at opposite sides of the non-corrugated region 811 by the two flexibility features 310. In particular, where each of the two flexibility features 310 define the plurality of recessed portions 711, such as shown for the illustrated embodiment here, the non-corrugated region 811 can be bounded at one side by the plurality of recessed portions 711 at the outer surface 316 of the central tube region 702 and bounded at another, opposite side by the plurality of recessed portions 711 at the outer surface 316 of the central tube region 702.

FIG. 8A illustrates the flexible tube connector 800 applied to rotatably connect together torque tubes 14A, 14B for the system 850. As noted, system 850 can include the flexible tube connector 800 and the bearing housing assembly 617 configured for rotatably connecting two torque tubes 14A, 14B of a solar tracker, such as described previously in reference to the system 750 at FIG. 7A. In addition to the flexible tube connector 800 and the bearing housing assembly 617, the system 850 can further include the first rail 755 and the second rail 756. As shown for the example at FIG. 8A, the first rail 755 can be coupled to the pin 604 at a first side of the housing 102 and the second rail 756 can be coupled to the pin 604 at a second, opposite side of the housing 102. The first rail 755 can be configured to couple to one of the torque tube 14A and the central tube region 702 (e.g., at the non-corrugated region 811) to rotatably support the torque tube 14A, and the second rail 756 can be configured to couple to one of the torque tube 14B and the central tube region 702 (e.g., at the non-corrugated region 811) to rotatably support the torque tube 14B. When the flexible tube connector 800 is applied to rotatably connect together torque tubes 14A, 14B for the system 850, such as shown at FIG. 8A, the first tube end portion 704 can have the one or more torque tube fastening apertures 305 at a location along the first tube end portion 704 longitudinally offset from a first end of the pin 604 a distance 859a, and the second tube end portion 706 can have the one or more torque tube fastening apertures 307 at a location along the second tube end portion 706 longitudinally offset from the first end of the pin 604 a distance 859b. For some applications, the distance 859a and the distance 859b can be generally equal.

FIG. 9 is an elevational view of another embodiment of a flexible tube connector 900 incorporated into a system 950 that includes the embodiment of the flexible tube connector 900 and the bearing housing assembly 617 configured for rotatably connecting two torque tubes 14A, 14B of a solar tracker. Except as otherwise illustrated and noted as follows, the flexible tube connector 900 can be as disclosed previously in reference to the flexible tube connector 700 at FIGS. 7A and 7B. In particular, the flexible tube connector 900 can be similar to, or the same as, the flexible tube connector 700 described and illustrated previously in reference to FIGS. 7A and 7B except that the flexible tube connector 900 can have, as illustrated, the central tube region 702 with the flexibility feature 310 shifted from a more central location at the central tube region 702, as illustrated for the flexible tube connector 700, instead to a more end region at the central tube region 702 closer to one of the first tube end portion 704 and the second tube end portion 706. The illustrated embodiment of the flexible tube connector 900 includes the flexibility feature 310 at an end region of the central tube region 702 that is adjacent to the second tube end portion 706. As also illustrated for flexible tube connector 900 at FIG. 9, the flexible tube connector 900 can include the flexibility feature 310 at a first side end region of the central tube region 702 that is adjacent to the second tube end portion 706 and include non-corrugated region 811 at a second, opposite side end region of the central tube region 702 that is adjacent to the first tube end portion 704.

FIG. 9 further illustrates the flexible tube connector 900 applied to rotatably connect together torque tubes 14A, 14B for the system 950. The system 950 can include the flexible tube connector 900 and the bearing housing assembly 617 configured for rotatably connecting two torque tubes 14A, 14B of a solar tracker, such as described previously in reference to the system 750 at FIG. 7A. In addition to the flexible tube connector 900 and the bearing housing assembly 617, the system 950 can further include the first rail 755 and the second rail 756. As shown for the example at FIG. 9, the first rail 755 can be coupled to the pin 604 at a first side of the housing 102 and the second rail 756 can be coupled to the pin 604 at a second, opposite side of the housing 102. The first rail 755 can be configured to couple to one of the torque tube 14A and the central tube region 702 (e.g., at the non-corrugated region 811) to rotatably support the torque tube 14A, and the second rail 756 can be configured to couple to one of the torque tube 14B and the central tube region 702 (e.g., at the non-corrugated region 811) to rotatably support the torque tube 14B. When the flexible tube connector 900 is applied to rotatably connect together torque tubes 14A, 14B for the system 950, such as shown at FIG. 9, the first tube end portion 704 can have the one or more torque tube fastening apertures 305 at a location along the first tube end portion 704 longitudinally offset from a first end of the pin 604 a distance 959a, and the second tube end portion 706 can have the one or more torque tube fastening apertures 307 at a location along the second tube end portion 706 longitudinally offset from the first end of the pin 604 a distance 959b. For some applications, the distance 959a can be less than the distance 959b. Also for some applications, the flexibility feature 310 (e.g., and the plurality of recessed portions 711) can be spaced apart from the first end of the pin 604 but less than the distance 959b.

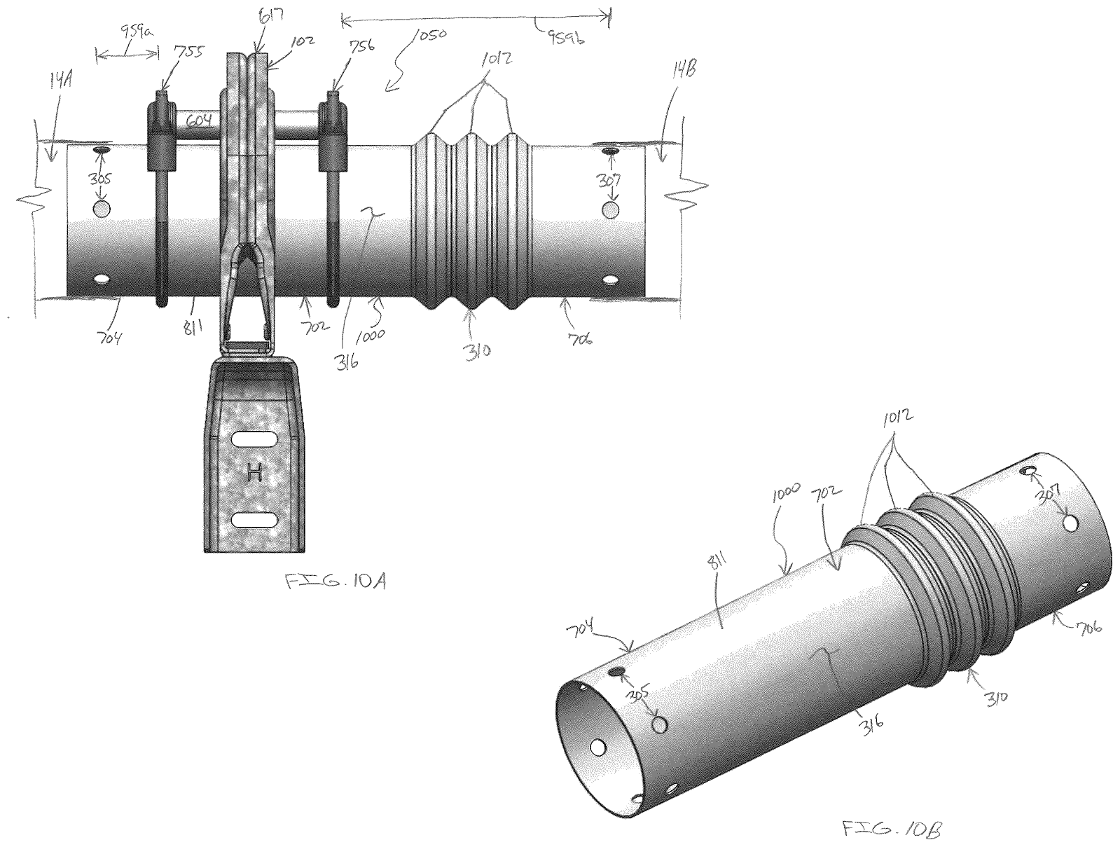

FIGS. 10A-10B illustrate a further embodiment of a flexible tube connector 1000. FIG. 10A is an elevational view of a system 1050 that includes the flexible tube connector 1000 and bearing housing assembly 617 configured for rotatably connecting two torque tubes 14A, 14B of a solar tracker. FIG. 10B is a perspective view of the flexible tube connector 1000 in isolation.

Except as otherwise illustrated and noted as follows, the flexible tube connector 1000 can be as disclosed previously in reference to the flexible tube connector 900 at FIG. 9. In particular, the flexible tube connector 1000 can be similar to, or the same as, the flexible tube connector 900 described and illustrated previously in reference to FIG. 9 except that the flexible tube connector 1000 can have, as illustrated, the flexibility feature 310 with a series of corrugations formed at the central tube region 702 by a plurality of projection portions 1012 instead of a plurality of recessed portions 711 as for the flexible tube connector 900. For example, the flexible tube connector 1000 can have, as illustrated, the flexibility feature 310 with the series of corrugations formed at the central tube region 702 by the plurality of projection portions 1012 at the outer surface 316 of the central tube region 702, such as adjacent to the second tube end portion 706 as illustrated here. The plurality of projection portions 1012 can be spaced apart from one another along at least a portion of the length of the central tube region 702. For instance, between the plurality of spaced apart projection portions 1012 can be portions of the central tube region 702 at a common elevation as portions of the central tube region adjacent to the first tube end portion 704. The flexible tube connector 1000 can include the non-corrugated region 811 along a portion of the length of the central tube region 702, such as adjacent to the first tube end portion 704, while the plurality of spaced apart projection portions 1012 can be adjacent to the second tube end portion 706.

The system 1050 illustrated at FIG. 10A shows the flexible tube connector 1000 applied to rotatably connect together torque tubes 14A, 14B. The system 1050 can include the flexible tube connector 1000 and the bearing housing assembly 617 configured for rotatably connecting two torque tubes 14A, 14B of a solar tracker, such as described previously in reference to the system 750 at FIG. 7A. In addition to the flexible tube connector 1000 and the bearing housing assembly 617, the system 1050 can further include the first rail 755 and the second rail 756. As shown for the example at FIG. 10A, the first rail 755 can be coupled to the pin 604 at a first side of the housing 102 and the second rail 756 can be coupled to the pin 604 at a second, opposite side of the housing 102. The first rail 755 can be configured to couple to one of the torque tube 14A and the central tube region 702 (e.g., at the non-corrugated region 811) to rotatably support the torque tube 14A, and the second rail 756 can be configured to couple to one of the torque tube 14B and the central tube region 702 (e.g., at the non-corrugated region 811) to rotatably support the torque tube 14B. When the flexible tube connector 1000 is applied to rotatably connect together torque tubes 14A, 14B for the system 1050, such as shown at FIG. 10A, the first tube end portion 704 can have the one or more torque tube fastening apertures 305 at a location along the first tube end portion 704 longitudinally offset from a first end of the pin 604 a distance 959a, and the second tube end portion 706 can have the one or more torque tube fastening apertures 307 at a location along the second tube end portion 706 longitudinally offset from the first end of the pin 604 a distance 959b. For some applications, the distance 959a can be less than the distance 959b. Also for some applications, the flexibility feature 310 (e.g., and the plurality of projection portions 1012) can be spaced apart from the first end of the pin 604 but less than the distance 959b.

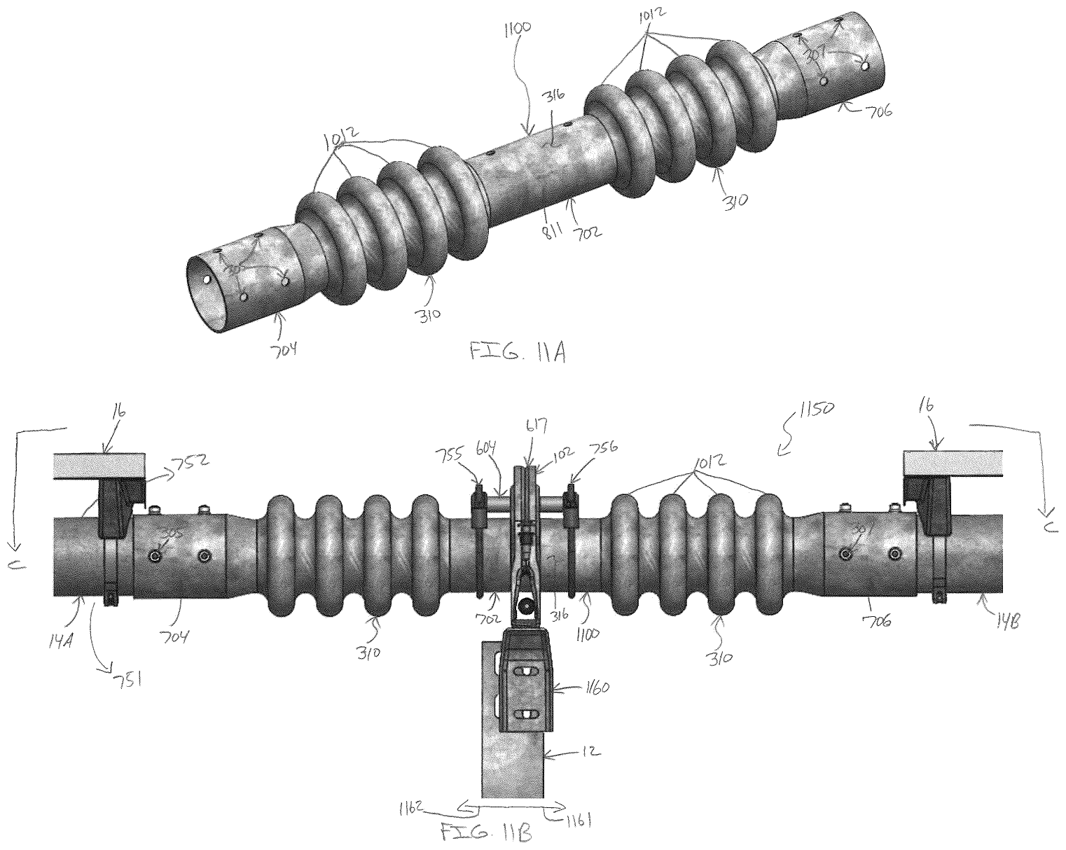

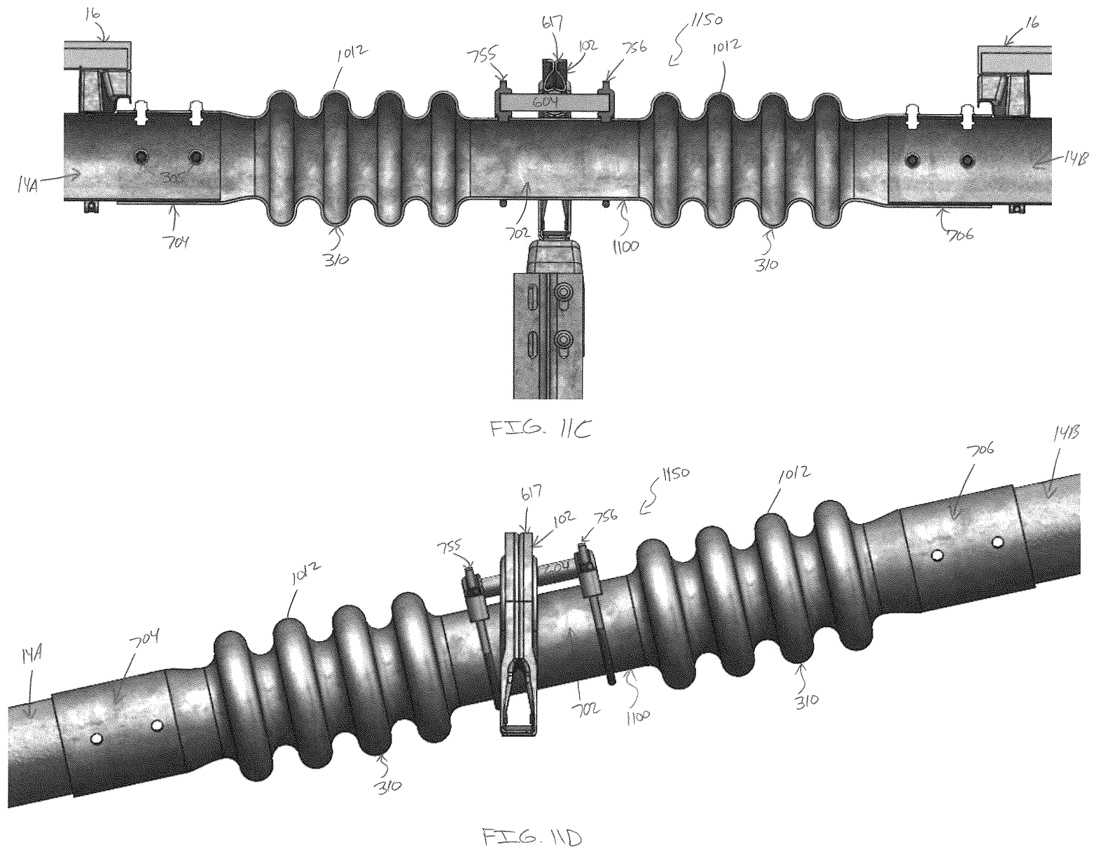

FIGS. 11A-11D illustrate another embodiment of a flexible tube connector 1100. FIG. 11A is a perspective view of the flexible tube connector 1100 in isolation, FIG. 11B is an elevational view of a system 1150 that includes the flexible tube connector 1100 and bearing housing assembly 617 configured for rotatably connecting two torque tubes 14A, 14B of a solar tracker, FIG. 11C is a cross-sectional view of the system 1150 taken along line C-C at FIG. 11B, and FIG. 11D is an elevational view of the system 1150 showing the bearing housing assembly 617 and flexible tube connector 1100 rotatably connecting two torque tubes 14A, 14B at one exemplary skewed angular orientation relative to the housing 102 of the bearing housing assembly 617.

Except as otherwise illustrated and noted as follows, the flexible tube connector 1100 can be as disclosed previously in reference to the flexible tube connector 800 at FIGS. 8A and 8B. In particular, the flexible tube connector 1100 can be similar to, or the same as, the flexible tube connector 800 described and illustrated previously in reference to FIGS. 8A and 8B except that the flexible tube connector 1100 can have, as illustrated, the two or more flexibility features 310, at the central tube region 702, with a series of corrugations formed at the central tube region 702 by a plurality of projection portions 1012 instead of a plurality of recessed portions 711 as for the flexible tube connector 800. For example, the central tube region 702, of the illustrated embodiment of the flexible tube connector 1100, can include non-corrugated region 811 and the at least two flexibility features 310 that each include the plurality of spaced apart projections 1012. The non-corrugated region 811 can define a generally constant diameter along a length of the outer surface 316 of the central tube region 702. For instance, as illustrated, the non-corrugated region 811 can extend along a portion of the length of the central tube region 702, and the non-corrugated region 811 can be bounded at opposite sides of the non-corrugated region 811 by the two flexibility features 310. In particular, where each of the two flexibility features 310 define the plurality of projection portions 1012, such as shown for the illustrated embodiment here at FIGS. 11A-11D, the non-corrugated region 811 can be bounded at one side by the plurality of projection portions 1012 at the outer surface 316 of the central tube region 702 and bounded at another, opposite side by the plurality of projection portions 1012 at the outer surface 316 of the central tube region 702.

FIGS. 11B-11D illustrates the flexible tube connector 1100 applied to rotatably connect together torque tubes 14A, 14B for the system 1150. As noted, system 1150 can include the flexible tube connector 1100 and the bearing housing assembly 617. In addition, the system 1150 can further include the first and second rails 755, 756 coupled to the pin 604 at opposite sides of the housing 102. The first rail 755 can be configured to couple to one of the torque tube 14A and the central tube region 702 (e.g., at the non-corrugated region 811) to rotatably support the torque tube 14A, and the second rail 756 can be configured to couple to one of the torque tube 14B and the central tube region 702 (e.g., at the non-corrugated region 811) to rotatably support the torque tube 14B.

As illustrated for one example at FIG. 11D, the system 1150 can utilize the bearing housing assembly 617 and an embodiment of the flexible tube connector (e.g., the flexible tube connector 1100 as shown at FIGS. 11B-11D) to accommodate a variety of angular orientations of the torque tube 14A and/or torque tube 14B relative to the bearing housing 102 of the bearing housing assembly 617. For instance, the system 1150 can utilize the bearing housing assembly 617 and an embodiment of the flexible tube connector (e.g., the flexible tube connector 1100 as shown at FIGS. 11B-11D) to accommodate a variety of skewed angular orientations of the torque tube 14A and/or torque tube 14B relative to the bearing housing 102 of the bearing housing assembly 617.

The example at FIG. 11D illustrates one exemplary skewed orientation of the torque tubes 14A, 14B relative to the bearing housing 102 facilitated by the pin 604 moved to a skewed angular orientation between horizontal and vertical relative to the bearing housing 102. In addition to the ability of the pin 604 to move to various angular orientations relative to the bearing housing 102, an embodiment of the flexible tube connector (e.g., the flexible tube connector 1100 as shown at FIGS. 11B-11D) can further facilitate additional various angular orientations between torque tubes 14A and 14B (e.g., relative to the bearing housing 102). For example, the pin 604 can be movable to various angular orientations relative to the bearing housing 102 to set a relative angular orientation between the bearing housing 102 and the collective, coupled together the flexible tube connector (e.g., flexible tube connector 1100), torque tube 14A, and torque tube 14B. And, in addition, the flexible tube connector (e.g., flexible tube connector 1100) can utilize the one or more tube flexibility features to set a relative angular orientation between the bearing housing 102 and the torque tube 14A and between the bearing housing 102 and the torque tube 14B. Thus, the features disclosed herein can be useful, for example, in providing the ability to tailor relative angular orientations between interconnected and movable solar tracker components as suited for a particular terrain gradient for a given solar tracker site.

For additional orientation accommodation and increased terrain gradient applications, the system 1150 can movably couple the bearing housing assembly 617 to a pier. As shown, for example, at FIG. 11B, the bearing housing assembly 617 can be coupled to pier 12 to support the bearing housing assembly 617, and thus the flexible tube connector 1100 and torque tubes 14A, 14B coupled thereto, at the ground surface. The illustrated embodiments shows a bracket 1160 used to couple the bearing housing 102 to the pier 12. As also shown here, the bracket 1160 can be movably coupled to the pier 12 such that the bracket 1160 can move relative to the pier 12 when the bracket 1160 is coupled to the pier 12. For example, the illustrated embodiment shows that the bracket 1160 can be movably coupled to the pier 12 such that the bracket 1160 can move relative to the pier 12 in directions 1161, 1162. This can in turn cause the bearing housing assembly 617, including the bearing housing 102, to be movable relative to the pier in the directions 1161, 1162 to provide further orientation accommodation and increased terrain gradient applications.

Various examples have been described. These and other examples are within the scope of the following claims.

What is claimed is:

1. A flexible tube connector comprising:
a central tube region;
a first tube end portion that extends out from one end of the central tube region, the first tube end portion configured to couple to a first torque tube of a solar tracker apparatus;
a second tube end portion that extends out from another, opposite end of the central tube region, the second tube end portion configured to couple to a second torque tube of the solar tracker apparatus; and
one or more flexibility features located at the central tube region,
wherein the one or more flexibility features are configured to cause the first tube end portion to connect to the first torque tube and the second tube end portion to connect to the second torque tube at a plurality of angular orientations.

2. The flexible tube connector of claim 1, wherein the first tube end portion comprises one or more torque tube fastening apertures, and wherein the second tube end portion comprise one or more torque tube fastening apertures.

3. The flexible tube connector of claim 2, wherein the one or more flexibility features are located between the one or more torque tube fastening apertures at the first tube end portion and the one or more torque tube fastening apertures at the second tube end portion.

4. The flexible tube connector of claim 1, wherein the one or more flexibility features are configured to cause the first tube end portion to connect to the first torque tube at a plurality of angular orientations relative to the central tube region, and wherein the one or more flexibility features are configured to cause the second tube end portion to connect to the second torque tube at a plurality of angular orientations relative to the central tube region.

5. The flexible tube connector of claim 1, wherein the one or more flexibility features comprise a series of corrugations at the central tube region.

6. The flexible tube connector of claim 5, wherein the series of corrugations at the central tube region include a plurality of recessed portions at an outer surface of the central tube region, the plurality of recessed portions spaced apart from one another along at least a portion of a length of the central tube region.

7. The flexible tube connector of claim 6, wherein each of the plurality of recessed portions extend around an entire perimeter of the outer surface of the central tube region.

8. The flexible tube connector of claim 6, wherein the central tube region comprises a non-corrugated region along a portion of the length of the central tube region, and wherein the non-corrugated region is bounded at one side by the plurality of recessed portions at the outer surface of the central tube region and bounded at another, opposite side by the plurality of recessed portions at the outer surface of the central tube region.

9. The flexible tube connector of claim 5, wherein the series of corrugations at the central tube region include a plurality of projection portions at an outer surface of the central tube region, the plurality of projection portions spaced apart from one another along at least a portion of a length of the central tube region.

10. The flexible tube connector of claim 9, wherein the central tube region comprises a non-corrugated region along a portion of the length of the central tube region, and wherein the non-corrugated region is bounded at one side by the plurality of projection portions at the outer surface of the central tube region and bounded at another, opposite side by the plurality of projection portions at the outer surface of the central tube region.

11. A system comprising:
a bearing housing assembly configured to rotatably support a first torque tube and a second torque tube, the bearing housing assembly comprising:
a housing;
a pin aperture at the housing;
a rotatable ring rotatably seated at the pin aperture; and
a pin received at the rotatable ring,
wherein the pin is configured to rotatably connect to at least one torque tube to cause the pin to rotate with the torque tube in a first plane, and
wherein the pin is configured to pivot with the rotatable ring in a second, different plane to change an angular orientation of the pin relative to the pin aperture; and
a flexible tube connector configured to connect to the first torque tube and the second torque tube at a plurality of angular orientations, the flexible tube connector comprising:
a central tube region;
a first tube end portion that extends out from one end of the central tube region, the first tube end portion configured to couple to a first torque tube of a solar tracker apparatus;
a second tube end portion that extends out from another, opposite end of the central tube region, the second tube end portion configured to couple to a second torque tube of the solar tracker apparatus; and
one or more flexibility features located at the central tube region,
wherein the one or more flexibility features are configured to cause the first tube end portion to connect to the first torque tube and the second tube end portion to connect to the second torque tube at a plurality of angular orientations.

12. The system of claim 11, wherein the pin is received at the rotatable ring spaced apart from and above the flexible tube connector.

13. The system of claim 12, wherein the housing of the bearing housing assembly is movable relative to the central tube region of the flexible tube connector.

14. The system of claim 11, further comprising:
a first rail coupled to the pin at a first side of the housing of the bearing housing assembly; and
a second rail coupled to the pin at a second, opposite side of the housing of the bearing housing assembly.

15. The system of claim 14, wherein the first rail is configured to couple to one of the first torque tube and the central tube region to rotatably support the first torque tube, and wherein the second rail is configured to couple to one of the second torque tube and the central tube region to rotatably support the second torque tube.

16. The system of claim 14, wherein the first tube end portion comprises one or more torque tube fastening apertures at a location along the first tube end portion longitudinally offset from a first end of the pin, and wherein the second tube end portion comprise one or more torque tube fastening apertures at a location along the second tube end portion longitudinally offset from the first end of the pin.

17. The system of claim 16, wherein the one or more flexibility features are located between the one or more torque tube fastening apertures at the first tube end portion and the one or more torque tube fastening apertures at the second tube end portion.

18. The system of claim 11, wherein the one or more flexibility features are configured to cause the first tube end portion to connect to the first torque tube at a plurality of angular orientations relative to the central tube region, and wherein the one or more flexibility features are configured to cause the second tube end portion to connect to the second torque tube at a plurality of angular orientations relative to the central tube region.

19. The system of claim 18, wherein the one or more flexibility features comprise a series of corrugations at the central tube region.

20. The system of claim 11, wherein the pin is configured to translate relative to the rotatable ring in each of a first radial direction away from the housing and a second, opposite radial direction away from the housing.
